(19) United States
(12) Patent Application Publication
(10) Pub. No.: US 2025/0326949 A1
(43) Pub. Date: Oct. 23, 2025

(54) A COATING COMPOSITION

(71) Applicant: PPG Industries Ohio, Inc., Cleveland, OH (US)

(72) Inventors: Fabio Werner Krohm, Ofterdingen (DE); Nigel Francis Masters, Romford (GB); Grzegorz Szczepan Kondziolka, Zebrzydowice (PL)

(73) Assignee: PPG Industries Ohio, Inc., Cleveland, OH (US)

(21) Appl. No.: 18/714,661

(22) PCT Filed: Nov. 29, 2022
(86) PCT No.: PCT/US2022/080533

§ 371 Date: May 30, 2024

Related U.S. Application Data
(60) Provisional application No. 63/285,525, filed on Dec. 3, 2021.

(51) Int. Cl. C09D 179/08; C09D 7/63

(52) U.S. Cl. CPC C09D 179/08; C09D 7/63

(57) ABSTRACT

A package coating on at least a portion thereof with a coating, the coating being derived from a coating composition, the coating composition comprising: a) a polyamide imide (PAI) resin, and b) a crosslinking agent comprising an isocyanate material and an epoxy material, wherein the coating composition is substantially free of pyrrolidone solvents.

### FIELD OF THE INVENTION

The present invention relates to a package, such as a food and/or beverage package or a monobloc aerosol can and/or tube, coated on at least a portion thereof with a coating, the coating being derived from a coating composition, the coating composition comprising a polyamide imide resin and a crosslinking agent comprising an isocyanate material and an epoxy material. The invention also extends to a method of of making a metal package having said coatings on at least a portion thereof.

### BACKGROUND OF THE INVENTION

The surfaces of containers, such as food and/or beverage containers, containers for personal care products or aerosol containers are required to be coated for various reasons. The external surfaces of such containers are often coated in a decorative manner and may allow printing thereon to inform a user as to the contents of the container. The internal surfaces of such container are typically coated to protect the container from the contents therein, which in some instances may be chemically aggressive. The coating on the container should also protect the contents from the container. There should be a minimal amount of alteration to the contents from materials that are products of erosion of the container, or from the coating itself. Accordingly, the coating composition used to coat the internal surfaces of the container should be designed such that it is able to withstand contact with these aggressive chemicals and to minimise the release of material from the metal of the container or the coating layer into the contents of the container.

A wide variety of coatings have been used to coat containers. With regard to food and/or beverage containers, the coating compositions are required to have certain properties such as being capable of high speed application, having excellent adhesion to the substrate, being safe for food contact and having properties once cured that are suitable for their end use.

Polyamide imide (PAI) resins are known binders for coatings. PAI resins are typically synthesised using pyrrolidone solvents, such as N-methyl pyrrolidone, which are potentially hazardous to humans (such as to human reproductivity, for example). It is desirable to reduce, or remove, the amount of pyrrolidone used in the synthesis of resins used in coating compositions for packaging end uses, such as food and/or beverage packaging, for example.

Coatings for packaging, such as food and/or beverage packaging, are typically cured at temperatures above 200° C., more typically at temperatures of about 230° C. It is desirable to reduce the curing temperature for cost and environmental considerations, for example. However, the coatings should retain the properties, such as high speed application, having excellent adhesion to the substrate, being safe for food contact and having properties once cured that are suitable for their end use, as discussed above.

It is an object of aspects of the present invention to provide a solution to one or more of the above mentioned problems.

### SUMMARY OF THE INVENTION

According to the present invention there is provided a package coating on at least a portion thereof with a coating, the coating being derived from a coating composition, the coating composition comprising:
a) a polyamide imide (PAI) resin, and
b) a crosslinking agent comprising an isocyanate material and an epoxy material,

wherein the coating composition is substantially free of pyrrolidone solvents.

There is also provided a food and/or beverage package coated on at least a portion thereof with a coating, the coating being derived from a coating composition, the coating composition comprising:
a) a polyamide imide (PAI) resin, and
b) a crosslinking agent comprising an isocyanate material and an epoxy material,

wherein the coating composition is substantially free of pyrrolidone solvents.

There is also provided a monobloc aerosol can and/or tube coated on at least a portion thereof with a coating, the coating being derived from a coating composition, the coating composition comprising:
a) a polyamide imide (PAI) resin, and
b) a crosslinking agent comprising an isocyanate material and an epoxy material,

wherein the coating composition is substantially free of pyrrolidone solvents.

There is also provided a method of making a metal package having a coating on at least a portion thereof, the method comprising the steps of:
i) applying a coating composition to at least a portion of a surface of a metal package, the coating composition comprising:
   a) a polyamide imide (PAI) resin, and
   b) a crosslinking agent comprising an isocyanate material and an epoxy material,
wherein the coating composition is substantially free of pyrrolidone solvents; and
ii) curing the coating composition to form a coating.

### DETAILED DESCRIPTION OF THE INVENTION

The coating composition comprises a polyamide imide (PAI) resin. Typically, the polyamide imide (PAI) resin comprises a polyamide linkage and an imide in the backbone of the polymer.

The polyamide imide (PAI) resin may be formed from an imide containing moiety. The imide containing moiety may also comprise an acid group and/or an alcohol group.

The imide containing moiety may contain a cyclic imide group.

The imide containing moiety may be formed as a reaction product between an amine or an isocyanate, such as a diisocyanate, with a cyclic anhydride.

The amine may comprise a primary amine.

Examples of suitable amines include, but are not limited to, diamines such as, for example, ethylene diamine, 1,3-propane diamine, tetramethylene diamine, 1,6-hexane diamine, trimethyl hexane-1,6-diamine, isophrone diamine, diaminodiphenylmethane (methylene dianaline), diaminodiphenylether, diaminodiphenylsulphone, methylene-4,4′-cyclohexyl diamine, benzoguanamine, ortho-xylylene diamine, meta-xylylene diamine, para-xylylenediamine, 1,2-cyclohexanediamine and 1,4-cyclohexanediamine; hydroxyamines such as, for example, monoethanol amine and monopropanolamine; aminocarboxylic acids such as, for example, glycine; aminopropionic acids; amino benzoic acids; and combinations thereof.

Examples of suitable isocyanates include, but are not limited to, diisocyanates such as, for example, hexamethylene di-isocyanate, tetramethylene di-isocyanate, isophorone di-isocyanate, methylene-4,4′-bis(cyclohexyl isocyanate), bis-(4-isocyanatocyclohexyl) methane, methylene di phenyl di-isocyanate, bis-(4-isocyanatophenyl) methane, tetramethyl-meta-xylylene di-isocyanate, meta xylylene di-isocyanate, para xylylene di-isocyanate, cyclohexane di-isocyanate, naphthalene di-isocyanate and trimethyl hexamethylene di-isocyanate; and combinations thereof.

Examples of suitable cyclic anhydrides include, but are not limited to, trimellitic anhydride; pyromellitic di-anhydride; maleic anhydride; 3,3′,4,4′-benzophenonetetracarboxylic dianhydride; tetrahydrophthalic anhydride; methyl tetrahydrophthalic anhydride; 4-methyl tetrahydrophthalic anhydride; hexahydrophthalic anhydride, 1,4,5,-naphthalenetricarboxylic anhydride; 1,4,5,8-naphthalenetetracarboxylic dianhydride; hemimellitic anhydride; and combinations thereof.

The imide containing moiety may be an acid substituted imide. By “acid substituted imide”, and like terms as used herein, is meant an imide containing moiety which comprises at least one carboxylic acid group. The imide containing moiety may also comprise an amine or isocyanate group. Thus, the imide containing moiety may comprise an imide linkage, an acid group and an amine or isocyanate group. For example, such moieties may be formed from the reaction of a trifunctional acid or anhydride thereof, such as trimellitic anhydride, with a diamine or diisocyanate.

The polyamide imide (PAI) resin may be formed by reaction of an imide containing moiety, such as one or more of the imide containing moieties described above, with a carboxylic acid, amine, or a component containing one acid and one amine group, as the case may be (depending on the functionality of the imide) to thereby form a polyamide imide (PAI) resin.

The polyamide imide (PAI) resin may be formed by reaction in the presence of a carboxylic acid, such as a monoacid, diacid or polyacid. The polyamide imide (PAI) resin may be formed by reaction in the presence of a monoacid. Examples of suitable acids include, but are not limited to, hexanoic acid, decanoic acid, lauric acid, myristic acid, palmitic acid, stearic acid, sorbic acid, benzoic acid, para-tertbutyl benzoic acid, cyclohexane dicarboxylic acid or combinations thereof.

“Monoacid” and like terms, as used herein, refers to a compound having one carboxylic acid group. The polyacid may be an organic polyacid.

“Polyacid” and like terms, as used herein, refers to a compound having two or more carboxylic acid groups, such as two, three or four carboxylic acid groups. The carboxylic acid groups of the polyacid may be connected by a bridging group selected from: an alkylene group; an alkenylene group; an alkynylene group; or an arylene group. The polyacid may be an organic polyacid.

Diacid” and like terms as used herein, refers to a compound having two carboxylic acid groups and includes an ester of the diacid (wherein an acid group is esterified) or an anhydride. The carboxylic acid groups of the diacid may be connected by a bridging group selected from: an alkylene group; an alkenylene group; an alkynylene group; or an arylene group. The diacid may be an organic diacid. Examples of suitable diacids include, but are not limited to, the following: isophthalic acid; terephthalic acid; 1,4-cyclohexane dicarboxylic acid; succinic acid; adipic acid; azelaic acid; sebacic acid; fumaric acid; 2,6-naphthalene dicarboxylic acid; orthophthalic acid. Diacids can also be used in the form of the diester materials, such as: dimethyl ester derivatives such as dimethyl isophthalate; dimethyl terephthalate; dimethyl-1,4-cyclohexane dicarboxylate; dimethyl-2,6-naphthalene dicarboxylate; dimethyl fumarate; dimethyl orthophthalate; dimethylsuccinate; dimethyl glutarate; dimethyl adipate; or combinations thereof. The term “alk” or “alkyl”, as used herein unless otherwise defined, relates to saturated hydrocarbon radicals being straight, branched, cyclic or polycyclic moieties or combinations thereof and contain 1 to 20 carbon atoms, such as 1 to 10 carbon atoms, such as 1 to 8 carbon atoms, such as 1 to 6 carbon atoms, or even 1 to 4 carbon atoms. These radicals may be optionally substituted with a chloro, bromo, iodo, cyano, nitro, OR¹⁹, OC(O)R²⁰, C(O)R²¹, C(O)OR²², NR²³R²⁴, C(O)NR²⁵R²⁶, SR²⁷, C(O)SR²⁷, C(S)NR²⁵R²⁶, aryl or Het, wherein R¹⁹ to R²⁷ each independently represent hydrogen, aryl or alkyl, and/or be interrupted by oxygen or sulphur atoms, or by silano or dialkylsiloxane groups. Examples of such radicals may be independently selected from methyl, ethyl, n-propyl, isopropyl, n-butyl, isobutyl, sec-butyl, tert-butyl, 2-methylbutyl, pentyl, iso-amyl, hexyl, cyclohexyl, 3-methylpentyl, octyl and the like. The term “alkylene”, as used herein, relates to a bivalent radical alkyl group as defined above. For example, an alkyl group such as methyl which would be represented as —CH₃, becomes methylene, —CH₂—, when represented as an alkylene. Other alkylene groups should be understood accordingly.

The term “alkenyl”, as used herein, relates to hydrocarbon radicals having, such as up to 4, double bonds, being straight, branched, cyclic or polycyclic moieties or combinations thereof and containing from 2 to 18 carbon atoms, such as 2 to 10 carbon atoms, such as from 2 to 8 carbon atoms, such as 2 to 6 carbon atoms, or even 2 to 4 carbon atoms. These radicals may be optionally substituted with a hydroxyl, chloro, bromo, iodo, cyano, nitro, OR¹⁹, OC(O)R²⁰, C(O)R²¹, C(O)OR²², NR²³R²⁴, C(O)NR²⁵R²⁶, SR²⁷, C(O)SR²⁷, C(S)NR²⁵R²⁶, or aryl, wherein R¹⁹ to R²⁷ each independently represent hydrogen, aryl or alkyl, and/or be interrupted by oxygen or sulphur atoms, or by silano or dialkylsiloxane groups. Examples of such radicals may be independently selected from alkenyl groups include vinyl, allyl, isopropenyl, pentenyl, hexenyl, heptenyl, cyclopropenyl, cyclobutenyl, cyclopentenyl, cyclohexenyl, 1-propenyl, 2-butenyl, 2-methyl-2-butenyl, isoprenyl, farnesyl, geranyl, geranylgeranyl and the like. The term “alkenylene”, as used herein, relates to a bivalent radical alkenyl group as defined above. For example, an alkenyl group such as ethenyl which would be represented as —CH═CH2, becomes ethenylene, —CH═CH—, when represented as an alkenylene. Other alkenylene groups should be understood accordingly.

The term “alkynyl”, as used herein, relates to hydrocarbon radicals having, such as up to 4, triple bonds, being straight, branched, cyclic or polycyclic moieties or combinations thereof and having from 2 to 18 carbon atoms, such as 2 to 10 carbon atoms, such as from 2 to 8 carbon atoms, such as from 2 to 6 carbon atoms, or even from 2 to 4 carbon atoms. These radicals may be optionally substituted with a hydroxy, chloro, bromo, iodo, cyano, nitro, OR¹⁹, OC(O)R²⁰, C(O)R²¹, C(O)OR²², NR²³R²⁴, C(O)NR²⁵R²⁶, SR²⁷, C(O)SR²⁷, C(S)NR²⁵R²⁶, or aryl, wherein R¹⁹ to R²⁷ each independently represent hydrogen, aryl or lower alkyl, and/or be interrupted by oxygen or sulphur atoms, or by silano or dialkylsiloxane groups. Examples of such radicals may be independently selected from alkynyl radicals include ethynyl, propynyl, propargyl, butynyl, pentynyl, hexynyl and the like. The term “alkynylene”, as used herein, relates to a bivalent radical alkynyl group as defined above. For example, an alkynyl group such as ethynyl which would be represented as —C≡CH, becomes ethynylene, —C≡C—, when represented as an alkynylene. Other alkynylene groups should be understood accordingly.

The term “aryl” as used herein, relates to an organic radical derived from an aromatic hydrocarbon by removal of one hydrogen, and includes any monocyclic, bicyclic or polycyclic carbon ring of up to 7 members in each ring, wherein at least one ring is aromatic. These radicals may be optionally substituted with a hydroxy, chloro, bromo, iodo, cyano, nitro, OR¹⁹, OC(O)R²⁰, C(O)R²¹, C(O)OR²², NR²³R²⁴, C(O)NR²⁵R²⁶, SR²⁷, C(O)SR²⁷, C(S)NR²⁵R²⁶, or aryl, wherein R¹⁹ to R²⁷ each independently represent hydrogen, aryl or lower alkyl, and/or be interrupted by oxygen or sulphur atoms, or by silano or dialkylsilcon groups. Examples of such radicals may be independently selected from phenyl, p-tolyl, 4-methoxyphenyl, 4-(tert-butoxy)phenyl, 3-methyl-4-methoxyphenyl, 4-fluorophenyl, 4-chlorophenyl, 3-nitrophenyl, 3-aminophenyl, 3-acetamidophenyl, 4-acetamidophenyl, 2-methyl-3-acetamidophenyl, 2-methyl-3-aminophenyl, 3-methyl-4-aminophenyl, 2-amino-3-methylphenyl, 2,4-dimethyl-3-aminophenyl, 4-hydroxyphenyl, 3-methyl-4-hydroxyphenyl, 1-naphthyl, 2-naphthyl, 3-amino-1-naphthyl, 2-methyl-3-amino-1-naphthyl, 6-amino-2-naphthyl, 4,6-dimethoxy-2-naphthyl, tetrahydronaphthyl, indanyl, biphenyl, phenanthryl, anthryl or acenaphthyl and the like. The term “arylene”, as used herein, relates to a bivalent radical aryl group as defined above. For example, an aryl group such as phenyl which would be represented as -Ph, becomes phenylene, -Ph-, when represented as an arylene. Other arylene groups should be understood accordingly.

For the avoidance of doubt, the reference to alkyl, alkenyl, alkynyl, aryl or aralkyl in composite groups herein should be interpreted accordingly, for example the reference to alkyl in aminoalkyl or alk in alkoxyl should be interpreted as alk or alkyl above etc.

The polyamide imide (PAI) resin may include a hydroxyl functional reactant, such as a diol or polyol, for example. Suitable diols include, but are not limited to, 2,2,4-trimethyl pentane 1,3-diol, trimethyl pentane diol, trimethyl hexane diol, 2,2,4-trimethyl hexane-1,6-diol, 2-ethyl 1,3 hexane diol, 2,2,4 hexane 1,6 diol, 1,6 hexane diol, di-hydroxypolyethylene glycols, di-hydroxypolypropylene glycol, di-hydroxydimethyl polysiloxane, di-hydroxydiphenyl polysiloxane and mixtures thereof.

The formation of the polyamide imide (PAI) resin may take place in the presence of a catalyst. Examples of suitable catalysts include, but are not limited to, p-toluenesulfonic acid (PTSA); organic tin oxides, such as dibutyl tin oxide; organic titanium compounds, such as monomeric and/or polymeric organic titanium compounds, for example, titanium butyl monomer and poly titanium butyl; organic cobalt salts, such as cobalt soaps; and combinations thereof and combinations thereof. However, in some cases catalysis may not be required.

The polyamide imide (PAI) resin may be formed by any suitable method. The polyamide imide (PAI) resin may be formed by a one-step reaction or a two-step reaction.

In a one step reaction, all the components may be reacted together at the same time, i.e. in a ‘one-pot’ reaction, which may be undertaken in the presence of a promoter/catalyst. The reaction may be carried out at any suitable temperature. The reaction may be carried out at sufficient temperature to allow for removal of carbon dioxide, water or alcohol by-products as the polymer is formed.

In a two step reaction, the polyamide imide (PAI) resin may be formed by first reacting a cyclic anhydride component with an amine and/or isocyanate component at a suitable temperature to produce an imide moiety with reactive functionality (imide preparation reaction), which may be undertaken in the presence of a promoter/catalyst. In a second stage reaction, the imide moiety may be reacted an alcohol, carboxylic acid and/or amine as described herein at a suitable temperature to produce the polyamide imide (PAI) resin, which may be undertaken in the presence of a promoter/catalyst. The first step reaction may be carried out at sufficient temperature to allow for removal of carbon dioxide, water or alcohol by-products as the polymer is formed. The second step reaction may be carried out at sufficient temperature to allow for removal of carbon dioxide, water or alcohol by-products as the polymer is formed.

A solvent may be used in the method to form the polyamide imide (PAI) resin. A solvent may be used to aid processing and production of the polyamide imide (PAI) resin by any of the methods herein described. One or more steps of the process, when a two-step process is used, may be carried out in the presence of a solvent.

The solvent used in the method to form the polyamide imide (PAI) resin may comprise any suitable solvent. The solvent or mixture of solvents used in the method to form the polyamide imide (PAI) resin may comprise an aprotic solvent, such as a polar aprotic solvent. Examples of suitable polar aprotic solvents include, but are not limited to, dibasic esters, ethylene glycol diacetate, benzyl acetate, methyl-n-amyl ketone, methyl isobutyl ketone, isophorone, cyclohexanone, cyclopentanone, acetophenone, propylene carbonate, ethylene carbonate, diethyl carbonate, dimethyl carbonate, gamma valerolactone, gamma butyrolactone, Cyrene, caprolactone, anisole, dimethylisosorbide, 1,4-dioxane, 1,3 dioxolane, ethyl 2-methyl-1,3-dioxolane-2-acetate, n-methyl morpholine, Proglyde DMM, 1-methoxy-2-(2-methoxyethoxymethoxy) ethane, dimethylsulphoxide, sulpholane, 3-methoxy-N,N′-dimethylpropionamide, methyl 5-(dimethylamino)-2-methyl-5-oxopentanoate and combinations thereof.

The polyamide imide polymer may be functionalised. The polyamide imide polymer may have functional end groups including hydroxyl groups, acid groups, amine groups or amide groups. For example, the polyamide imide polymer may be acid functionalised, amino functionalised, amide functionalised and/or hydroxy functionalised.

The polyamide imide (PAI) resin suitably comprises at least one amide linkage and at least one imide linkage in the polymer backbone. The polyamide imide (PAI) resin may comprise any suitable molar ratio of imide to amide linkages.

The polyamide imide (PAI) resin may comprise any suitable molar amount of imide linkages. The polyamide imide (PAI) resin may comprise from 5 to 80 mol %, such as from 8 to 60 mol %, such as from 10 to 45 mol %, or even from 12 to 35 mol % of imide linkages based on the total number of moles of imide and amide linkages present in the polymer backbone.

The polyamide imide (PAI) resin may comprise at least 5 mol %, such as at least 8 mol %, such as at least 10 mol %, or even at least 12 mol % of imide linkages based on the total number of moles of imide and amide linkages present in the polymer backbone. The polyamide imide (PAI) resin may comprise up to 80 mol %, such as up to 60 mol %, such as up to 45 mol %, or even up to 35 mol % of imide linkages based on the total number of moles of imide and amide linkages present in the polymer backbone. The polyamide imide (PAI) resin may comprise from 5 to 80 mol %, such as from 5 to 60 mol %, such as from 5 to 45 mol %, or even from 5 to 35 mol % of imide linkages based on the total number of moles of imide and amide linkages present in the polymer backbone. The polyamide imide (PAI) resin may comprise from 8 to 80 mol %, such as from 8 to 60 mol %, such as from 8 to 45 mol %, or even from 8 to 35 mol % of imide linkages based on the total number of moles of imide and amide linkages present in the polymer backbone. The polyamide imide (PAI) resin may comprise from 10 to 80 mol %, such as from 10 to 60 mol %, such as from 10 to 45 mol %, or even from 10 to 35 mol % of imide linkages based on the total number of moles of imide and amide linkages present in the polymer backbone. The polyamide imide (PAI) resin may comprise from 12 to 80 mol %, such as from 12 to 60 mol %, such as from 12 to 45 mol %, or even from 12 to 35 mol % of imide linkages based on the total number of moles of imide and amide linkages present in the polymer backbone.

The polyamide imide (PAI) resin may comprise any suitable molar amount of amide linkages. The polyamide imide (PAI) resin may comprise from 20 to 95 mol %, such as from 40 to 92 mol %, such as from 55 to 90 mol %, or even from 65 to 88 mol % of amide linkages based on the total number of moles of imide and amide linkages present in the polymer backbone.

The polyamide imide (PAI) resin may comprise at least 20%, such as at least 40%, such as at least 55%, or even at least 65% of amide linkages based on the total number of moles of imide and amide linkages present in the polymer backbone. The polyamide imide (PAI) resin may comprise up to 95 mol %, such as up to 92 mol %, such as up to 90 mol %, or even up to 88 mol % of amide linkages based on the total number of moles of imide and amide linkages present in the polymer backbone. The polyamide imide (PAI) resin may comprise from 20 to 95 mol %, such as from 20 to 92 mol %, such as from 20 to 90 mol %, such as from 20 to 88 mol % of amide linkages based on the total number of moles of imide and amide linkages present in the polymer backbone. The polyamide imide (PAI) resin may comprise from 40 to 95 mol %, such as from 40 to 92 mol %, such as from 40 to 90 mol %, such as from 40 to 88 mol % of amide linkages based on the total number of moles of imide and amide linkages present in the polymer backbone. The polyamide imide (PAI) resin may comprise from 55 to 95 mol %, such as from 55 to 92 mol %, such as from 55 to 90 mol %, such as from 55 to 88 mol % of amide linkages based on the total number of moles of imide and amide linkages present in the polymer backbone. The polyamide imide (PAI) resin may comprise from 65 to 95 mol %, such as from 65 to 92 mol %, such as from 65 to 90 mol %, such as from 65 to 88 mol % of amide linkages based on the total number of moles of imide and amide linkages present in the polymer backbone.

It will be appreciated by a person skilled in the art that the total molar amount of imide and amide linkages present in the polyamide imide (PAI) polymer backbone will equal 100 mol % when based on the total number of moles of imide and amide linkages present in the polymer backbone.

As reported herein, the molar amount of imide and amide linkages present in the polymer backbone of the polyamide imide (PAI) resin was calculated based on the molar proportions of the components used to form the polyamide imide (PAI) resin. In this method, reference is made to the ratio of the number of moles of imide forming groups and amide forming groups. This was then used to calculate each of a % imide equivalent and % amide equivalent, as per the calculations below:

$$[ mols of imide forming group \times 100 ] / [ ( mols of imide forming group ) + ( mols of amide forming group ) ]$$

$$[ mols of amide forming group \times 100 ] / [ ( mols of imide forming group ) + ( mols of amide forming group ) ]$$

wherein it was assumed that all anhydride groups formed imide linkages and all carboxylic groups available to form a polymer linkage (i.e. excluding carboxylic acids at chain ends which are recorded in the acid value for the polyamide imide (PAI) resin) formed amide linkages.

All values for the molar amount of imide and amide linkages present in the polyamide imide (PAI) polymer backbone were measured in this way unless specified otherwise.

The polyamide imide (PAI) resin may further comprise one or more urethane linkage(s) in the polymer backbone. For example, the polyamide imide (PAI) resin may comprise up to 45 mol %, such as up to 35 mol %, such as up to 25 mol %, such as up to 10 mol %, or even up to 5 mol % of urethane linkages in the polymer backbone based on the total number of amide, imide and urethane linkages present in said polymer backbone.

As reported herein, the molar amount of urethane linkages, when present, in the polymer backbone of the polyamide imide (PAI) resin was calculated based on the molar proportions of the components used to form the polyamide imide (PAI) resin. In this method, reference is made to the ratio of the number of moles of imide forming groups, amide forming groups and urethane forming groups. This was then used to calculate a % urethane equivalent, as per the calculations below:

$$[ mols of urethane forming group \times 100 ] / [ ( mols of imide forming group ) + ( mols of amide forming group ) + ( mols of urethane forming group ) ]$$

wherein it was assumed that all hydroxyl groups formed urethane linkages.

The polyamide imide (PAI) resin may further comprise one or more ester linkage(s) in the polymer backbone. The polyamide imide (PAI) resin may typically comprise little or no ester linkages in the polymer backbone. For example, the polyamide imide (PAI) resin may comprise up to 10 mol %, such as up to 5 mol %, such as up to 2 mol %, such as up to 1 mol %, such as up to 0.5 mol %, or even up to 0.1 mol % of ester linkages in the polymer backbone based on the total number of amide, imide and ester linkages present in said polymer backbone.

The polyamide imide (PAI) resin may comprise no, i.e. 0 mol %, of ester linkages in the polymer backbone based on the total number of amide, imide and ester linkages present in said polymer backbone. Thus, the polyamide imide (PAI) resin may comprise only imide and amide linkages in the polymer backbone of said polyamide imide (PAI) resin.

As reported herein, the molar amount of ester linkages, when present, in the polymer backbone of the polyamide imide (PAI) resin was calculated based on the molar proportions of the components used to form the polyamide imide (PAI) resin. In this method, reference is made to the ratio of the number of moles of imide forming groups, amide forming groups and ester forming groups. This was then used to calculate a % ester equivalent, as per the calculations below:

$$[ mols of ester forming group \times 100 ] / [ ( mols of imide forming group ) + ( mols of amide forming group ) + ( mols of ester forming group ) ]$$

For the avoidance of doubt, when one or more ester linkages are present in the polyamide imide (PAI) polymer backbone, the values for the amount of imide and amide linkages also present may be as already recited herein.

The polyamide imide (PAI) resin may have any suitable acid value (AV; also known as acid number or AN). The polyamide imide (PAI) resin may have an acid value (AV) of at least 5 mg KOH/g, such as at least 10 mg KOH/g, such as at least 15 mg KOH/g, such as at least 20 mg KOH/g, such as at least 25 mg KOH/g, such as at least 30 mg KOH/g, such as at least 35 mg KOH/g, such as at least 40 mg KOH/g, such as at least 42 mg KOH/g, such as at least 44 mg KOH/g, such as at least 46 mg KOH/g, such as at least 48 mg KOH/g, or even at least 50 mg KOH/g.

The polyamide imide (PAI) resin may have an acid value of up to 250 mg KOH/g, such as up to 200 mg KOH/g, such as up to 150 mg KOH/g, such as up to 100 mg KOH/g, or even up to 75 mg KOH/g.

The polyamide imide (PAI) resin may have an acid value of from 5 to 250 mg KOH/g, such as from 5 to 200 mg KOH/g, such as from 5 to 150 mg KOH/g, such as from 5 to 100 mg KOH/g, such as from 5 to 75 mg KOH/g. The polyamide imide (PAI) resin may have an acid value of from 10 to 250 mg KOH/g, such as from 10 to 200 mg KOH/g, such as from 10 to 150 mg KOH/g, such as from 10 to 100 mg KOH/g, such as from 10 to 75 mg KOH/g. The polyamide imide (PAI) resin may have an acid value of from 5 to 250 mg KOH/g, such as from 15 to 200 mg KOH/g, such as from 15 to 150 mg KOH/g, such as from 15 to 100 mg KOH/g, such as from 15 to 75 mg KOH/g The polyamide imide (PAI) resin may have an acid value from 20 to 250 mg KOH/g, such as from 20 to 200 mg KOH/g, such as from 20 to 150 mg KOH/g, such as from 20 to 100 mg KOH/g, such as from 20 to 75 mg KOH/g. The polyamide imide (PAI) resin may have an acid value of from 25 to 250 mg KOH/g, such as from 25 to 200 mg KOH/g, such as from 25 to 150 mg KOH/g, such as from 25 to 100 mg KOH/g, such as from 25 to 75 mg KOH/g. The polyamide imide (PAI) resin may have an acid value of from 30 to 250 mg KOH/g, such as from 30 to 200 mg KOH/g, such as from 30 to 150 mg KOH/g, such as from 30 to 100 mg KOH/g, such as from 30 to 75 mg KOH/g. The polyamide imide (PAI) resin may have an acid value of from 35 to 250 mg KOH/g, such as from 35 to 200 mg KOH/g, such as from 35 to 150 mg KOH/g, such as from 35 to 100 mg KOH/g, such as from 35 to 75 mg KOH/g. The polyamide imide (PAI) resin may have an acid value of from 40 to 250 mg KOH/g, such as from 40 to 200 mg KOH/g, such as from 40 to 150 mg KOH/g, such as from 40 to 100 mg KOH/g, such as from 40 to 75 mg KOH/g. The polyamide imide (PAI) resin may have an acid value of from 42 to 250 mg KOH/g, such as from 42 to 200 mg KOH/g, such as from 42 to 150 mg KOH/g, such as from 42 to 100 mg KOH/g, such as from 42 to 75 mg KOH/g. The polyamide imide (PAI) resin may have an acid value of from 44 to 250 mg KOH/g, such as from 44 to 200 mg KOH/g, such as from 44 to 150 mg KOH/g, such as from 44 to 100 mg KOH/g, such as from 44 to 75 mg KOH/g. The polyamide imide (PAI) resin may have an acid value of from 46 to 250 mg KOH/g, such as from 46 to 200 mg KOH/g, such as from 46 to 150 mg KOH/g, such as from 46 to 100 mg KOH/g, such as from 46 to 75 mg KOH/g. The polyamide imide (PAI) resin may have an acid value of from 48 to 250 mg KOH/g, such as from 48 to 200 mg KOH/g, such as from 48 to 150 mg KOH/g, such as from 48 to 100 mg KOH/g, such as from 48 to 75 mg KOH/g. The polyamide imide (PAI) resin may have an acid value of from 50 to 250 mg KOH/g, such as from 50 to 200 mg KOH/g, such as from 50 to 150 mg KOH/g, such as from 50 to 100 mg KOH/g, such as from 50 to 75 mg KOH/g.

The polyamide imide (PAI) resin may have an acid value from 15 to 100 mg KOH/g.

The polyamide imide (PAI) resin may have an acid value from 30 to 75 mg KOH/g.

The polyamide imide (PAI) resin may have an acid value from 45 to 55 mg KOH/g.

The acid value is suitably expressed on solids.

As reported herein, the acid value was determined by titration with 0.1N methanolic potassium hydroxide solution. The sample of polymer (0.1-3 grams depending on acid value) was weighed accurately (on a balance with accuracy to weigh in milligrams) into a conical flask and was then dissolved in 25 millilitres of a solvent mixture containing dichloromethane and ethanol (3/1 w/w) and a few drops of 0.1% solution bromo thymol blue indicator; using light heating and stirring as appropriate. The solution was then cooled to room temperature (20-30° C.) and the solution titrated with the potassium hydroxide solution. The resulting acid value (acid number) is expressed in units of mg KOH/g and is calculated using the following equation.

$$Acid Value = ( titre KOH solution ( mls ) \times Molarity KOH solution \times 56.1 ) / Weight of solid sample ( grams )$$

All values for acid value reported herein were measured in this way.

The polyamide imide (PAI) resin may have any suitable hydroxyl value (OHV). The polyamide imide (PAI) resin may have a hydroxyl value up to 2 mg KOH/g, such as up to 1 mg KOH/g, or even of 0 mg KOH/g. It will be appreciated by a person skilled in the art that the polyamide imide (PAI) resin typically has a low hydroxyl value, such as up to 2 mg KOH/g, such as up to 1 mg KOH/g, or even of 0 mg KOH/g.

The hydroxyl value (OHV) is suitably expressed on solids.

As reported herein, the hydroxyl value is the number of mg of KOH equivalent to the hydroxyl groups in 1 g of material. In such as method, a sample (typically, 0.1 to 3 g) was weighed accurately into a conical flask and is dissolved, using light heating and stirring as appropriate, in 20 ml of tetrahydrofuran. 10 ml of 0.1M 4-(dimethylamino)pyridine in tetrahydrofuran (catalyst solution) and 5 ml of a 9 vol % solution of acetic anhydride in tetrahydrofuran (i.e. 90 ml acetic anhydride in 910 ml tetrahydrofuran; acetylating solution) were then added to the mixture. After 5 minutes, 10 ml of an 80 vol % solution of tetrahydrofuran (i.e. 4 volume parts tetrahydrofuran to 1 part distilled water; hydrolysis solution) was added. After 15 minutes, 10 ml tetrahydrofuran was added and the solution is titrated with 0.5M ethanolic potassium hydroxide (KOH). A blank sample was also run where the sample of solid polyamide is omitted. The resulting hydroxyl number is expressed in units of mg KOH/g and is calculated using the following equation:

$$Hydroxyl value = ( ( {V}_{2} - {V}_{1} ) \times molarity of KOH solution ( M ) \times 56.1 ) / weight of solid sample ( g )$$

wherein V₁ is the titre of KOH solution (ml) of the polyamide sample and V₂ is the titre of KOH solution (ml) of the blank sample.

All values for hydroxyl value reported herein were measured in this way.

The polyamide imide (PAI) resin may have any suitable number-average molecular weight (Mn). The polyamide imide (PAI) resin may have an Mn of at least 100 Daltons (Da=g/mole), such as at least 250 Da, such as at least 500 Da, such as at least 1,000 Da, such as at least 1,500 Da, such as at least 2,000 Da, such as at least 2,500 Da. The polyamide imide (PAI) resin may have an Mn up to 200,000 Da, such as up to 100,000 Da, such as up to 50,000 Da, such as up to 20,000 Da, such as up to 10,000 Da, such as up to 5,000 Da.

The polyamide imide (PAI) resin may have an Mn from 100 to 200,000 Da, such as from 250 to 200,000 Da, such as from 500 to 200,000 Da, such as from 1,000 to 200,000 Da, such as from 1,500 to 200,000 Da, such as from 2,000 to 200,000 Da, such as from 2,500 to 200,000 Da. The polyamide imide (PAI) resin may have an Mn from 100 to 100,000 Da, such as from 250 to 100,000 Da, such as from 500 to 100,000 Da, such as from 1,000 to 100,000 Da, such as from 1,500 to 100,000 Da, such as from 2,000 to 100,000 Da, such as from 2,500 to 100,000 Da. The polyamide imide (PAI) resin may have an Mn from 100 to 50,000 Da, such as from 250 to 50,000 Da, such as from 500 to 50,000 Da, such as from 1,000 to 50,000 Da, such as from 1,500 to 50,000 Da, such as from 2,000 to 50,000 Da, such as from 2,500 to 50,000 Da. The polyamide imide (PAI) resin may have an Mn from 100 to 20,000 Da, such as from 250 to 20,000 Da, such as from 500 to 20,000 Da, such as from 1,000 to 20,000 Da, such as from 1,500 to 20,000 Da, such as from 2,000 to 20,000 Da, such as from 2,500 to 20,000 Da. The polyamide imide (PAI) resin may have an Mn from 100 to 10,000 Da, such as from 250 to 10,000 Da, such as from 500 to 10,000 Da, such as from 1,000 to 10,000 Da, such as from 1,500 to 10,000 Da, such as from 2,000 to 10,000 Da, such as from 2,500 to 10,000 Da. The polyamide imide (PAI) resin may have an Mn from 100 to 5,000 Da, such as from 250 to 5,000 Da, such as from 500 to 5,000 Da, such as from 1,000 to 5,000 Da, such as from 1,500 to 5,000 Da, such as from 2,000 to 5,000 Da, such as from 2,500 to 5,000 Da.

The polyamide imide (PAI) resin may have an Mn from 2,500 to 5,000 Da.

As reported herein, the Mn was determined by gel permeation chromatography using a polystyrene standard according to ASTM D6579-11 (“Standard Practice for Molecular Weight Averages and Molecular Weight Distribution of Hydrocarbon, Rosin and Terpene Resins by Size Exclusion Chromatography”. UV detector; 254 nm, solvent: N-methyl pyrrolidone containing 0.1% LiBr, retention time marker: toluene, sample concentration: 2 mg/ml).

All values for Mn reported herein were measured in this way.

The polyamide imide (PAI) resin may have any suitable weight-average molecular weight (Mw). The polyamide imide (PAI) resin may have an Mw of at least 100 Daltons (Da=g/mole), such as at least 250 Da, such as at least 500 Da, such as at least 1,000 Da, such as at least 2,000 Da, such as at least 3,000 Da, such as at least 4,000 Da, such as at least 5,000 Da. The polyamide imide (PAI) resin may have an Mw up to 200,000 Da, such as up to 100,000 Da, such as up to 50,000 Da, such as up to 25,000 Da, such as up to 20,000 Da, such as up to 15,000 Da.

The polyamide imide (PAI) resin may have an Mw from 100 to 200,000 Da, such as from 250 to 200,000 Da, such as from 500 to 200,000 Da, such as from 1,000 to 200,000 Da, such as from 2,000 to 200,000 Da, such as from 3,000 to 200,000 Da, such as from 4,000 to 200,000 Da, such as from 5,000 to 200,000 Da. The polyamide imide (PAI) resin may have an Mw from 100 to 100,000 Da, such as from 250 to 100,000 Da, such as from 500 to 100,000 Da, such as from 1,000 to 100,000 Da, such as from 2,000 to 100,000 Da, such as from 3,000 to 100,000 Da, such as from 4,000 to 100,000 Da, such as from 5,000 to 100,000 Da. The polyamide imide (PAI) resin may have an Mw from 100 to 50,000 Da, such as from 250 to 50,000 Da, such as from 500 to 50,000 Da, such as from 1,000 to 50,000 Da, such as from 2,000 to 50,000 Da, such as from 3,000 to 50,000 Da, such as from 4,000 to 50,000 Da, such as from 5,000 to 50,000 Da. The polyamide imide (PAI) resin may have an Mw from 100 to 25.00 Da, such as from 250 to 25,000 Da, such as from 500 to 25,000 Da, such as from 1,000 to 25,000 Da, such as from 2,000 to 25,000 Da, such as from 3,000 to 25,000 Da, such as from 4,000 to 25,000 Da, such as from 5,000 to 25,000 Da. The polyamide imide (PAI) resin may have an Mw from 100 to 20,000 Da, such as from 250 to 20,000 Da, such as from 500 to 20,000 Da, such as from 1,000 to 20,000 Da, such as from 2,000 to 20,000 Da, such as from 3,000 to 20,000 Da, such as from 4,000 to 20,000 Da, such as from 5,000 to 20,000 Da. The polyamide imide (PAI) resin may have an Mw from 100 to 15,000 Da, such as from 250 to 15,000 Da, such as from 500 to 15,000 Da, such as from 1,000 to 15,000 Da, such as from 2,000 to 15,000 Da, such as from 3,000 to 15,000 Da, such as from 4,000 to 15,000 Da, such as from 5,000 to 15,000 Da.

The polyamide imide (PAI) resin may have an Mw from 5,000 to 15,000 Da.

As reported herein, the Mw was determined by gel permeation chromatography using a polystyrene standard according to ASTM D6579-11 (“Standard Practice for Molecular Weight Averages and Molecular Weight Distribution of Hydrocarbon, Rosin and Terpene Resins by Size Exclusion Chromatography”. UV detector; 254 nm, solvent: N-methyl pyrrolidone containing 0.1% LiBr, retention time marker: toluene, sample concentration: 2 mg/ml).

All values for Mw reported herein were measured in this way.

The polyamide imide (PAI) resin may be in solid form at room temperature and at atmospheric pressure.

The coating compositions may comprise any suitable amount of polyamide imide (PAI) resin. The coating composition may comprise from 10 to 99.9 wt %, such as from 25 to 99 wt %, such as from 30 to 90 wt %, such as from 40 to 80 wt % of the polyamide imide (PAI) resin based on the total solid weight of the coating composition.

The coating compositions may comprise at least 10 wt %, such as at least 25 wt %, such as at least 30 wt %, such as at least 40 wt % of the polyamide imide (PAI) resin based on the total solid weight of the coating composition. The coating compositions may comprise up to 99.9 wt %, such as up to 99 wt %, such as up to 90 wt %, or even up to 80 wt % of the polyamide imide (PAI) resin based on the total solid weight of the coating composition. The coating composition may comprise from 10 to 99.9 wt %, such as from 25 to 99.9 wt %, such as from 30 to 99.9 wt %, such as from 40 to 99.9 wt % of the polyamide imide (PAI) resin based on the total solid weight of the coating composition. The coating composition may comprise from 10 to 99 wt %, such as from 25 to 99 wt %, such as from 30 to 99 wt %, such as from 40 to 99 wt % of the polyamide imide (PAI) resin based on the total solid weight of the coating composition. The coating composition may comprise from 10 to 90 wt %, such as from 25 to 90 wt %, such as from 30 to 90 wt %, such as from 40 to 90 wt % of the polyamide imide (PAI) resin based on the total solid weight of the coating composition. The coating composition may comprise from 10 to 80 wt %, such as from 25 to 80 wt %, such as from 30 to 80 wt %, such as from 40 to 80 wt % of the polyamide imide (PAI) resin based on the total solid weight of the coating composition.

The coating composition comprises a crosslinking agent. The crosslinking agent comprises an isocyanate material and an epoxy material. The crosslinking agent is operable to crosslink the polyamide imide (PAI) resin. The crosslinking agent may be operable to crosslink acid functional groups of the polyamide imide (PAI) resin.

The isocyanate material may be any suitable isocyanate material. The isocyanate material may be a single molecule, a dimer, a trimer, an oligomer, a (co) polymer or a mixture thereof.

The isocyanate material may comprise optionally blocked or partially blocked isocyanate materials based on IPDI (isophorone diisocyanate), HDI (hexamethylene diisocyanate), PDI (phenylene diisocyanate), MDI (methylene diphenyl diisocyanate) and/or TDI (toluene diisocyanate).

Suitable examples of an isocyanate material include but are not limited to the following: internally blocked isocyanate, such as those sold under the trade name VESTAGON (RTM) commercially available from Evonik Industries, for example VESTAGON EP-B 1190; isophorone diisocyanate (IPDI), such as those sold under the trade name DESMODUR (RTM) commercially available from Covestro, for example DESMODUR VP-LS 2078/2, DESMODUR BL 3370, DESMODUR Z 4470, DESMODUR 2078/2 or DESMODUR PL 340 or those sold under the trade name VESTANAT (RTM) commercially available from Evonik, for example VESTANANT B 1370, VESTANAT B 118 6A, VESTANAT B 1042 E, VESTANAT T 1890/100 or VESTANAT B 1358 A; caprolactam-blocked IPDI material, such as those sold under the trade name VESTAGON (RTM) commercially available from Evonik Industries, for example VESTANAT 1186A; blocked cycloaliphatic isocyanate, such as those sold under the trade name VESTANAT (RTM) commercially available from Evonik Industries, for example VESTANAT B 1358 or VESTANAT B 1042 E; cycloalphatic polyisocyanate based on IPDI, such as those sold under the trade name VESTANAT (RTM) commercially available from Evonik Industries, for example VESTANAT T 1890/100; blocked aliphatic polyisocyanate based on hexamethylene diisocyanate (HDI), such as those sold under the trade name DESMODUR (RTM) commercially available from Covestro, for example DESMODUR PL 350, DESMODUR BL 3370, DESMODUR BL 3175 SN, DESMODUR PL340 or DESMODUR PL 3370, those sold under the trade name DURANATE (RTM) commercially available from Asahi KASEI, for example DURANATE MF-K60X, those sold under the trade name TOLONATE (RTM) commercially available from Vencorex Chemicals, for example TOLONATE D2 or those sold under the trade name TRIXENE (RTM) commercially available from Baxenden, for example TRIXENE-BI-7984, TRIXENE-BI-7963 or TRIXENE 7981 or those sold under the trade name VESTAGON (RTM) commercially available from Evonik, for example VESTAGON EP-B 1190; blocked aliphatic polyisocyanate based on IPDI, such as those sold under the trade name DESMODUR (RTM) commercially available from Covestro, for example DESMODUR PL 340; aliphatic DIPA-blocked polyisocyanate prepolymer based on HDI, such as those sold under the trade name DESMODUR (RTM) commercially available from Covestro, for example DESMODUR BL 3370; aliphatic polyisocyanate trimer based on IPDI, such as those sold under the trade name DESMODUR (RTM) commercially available from Covestro, for example DESMODUR Z 4470; blocked aliphatic polyisocyanate based on IPDI, such as those sold under the trade name DESMODUR (RTM) commercially available from Covestro, for example DESMODUR 2078/2; bio-based aliphatic polyisocyanate based on PDI trimer, such as those sold under the trade name DESMODUR (RTM) commercially available from Covestro, for example DESMODUR ECO N7300; aliphatic MEKO-blocked polyisocyanate prepolymer based on HDI, such as those sold under the trade name TOLONATE (RTM) commercially available from Vencorex, for example TOLONATE D2; DEM blocked isocyanate based on HDI, such as those sold under the trade name TRIXENE (RTM) commercially available from Lanxess, for example TRIXENE BI 7963.

The epoxy material may comprise any suitable epoxy material. The epoxy material may be a single molecule, a dimer, a trimer, an oligomer, a (co) polymer or a mixture thereof.

Suitable examples of epoxy materials include but are not limited to the following: diglycidyl ether of cyclohexane dimethanol, such as those sold under the trade name ARALDITE (RTM) commercially available from Hunstman, for example, ARALDITE DY-C; diglycidyl ether of 1,4-butanediol, such as those sold under the trade name ARALDITE (RTM) commercially available from Huntsman, for example. ARALDITE DY-D; diglycidyl ether of polyoxypropylene glycol, such as those sold under the trade name ARALDITE (RTM) commercially available from Hunstman, for example, ARALDITE DY-F; triglycidyl ether of trimethylol propane, such as those sold under the trade name ARALDITE (RTM) commercially available from Hunstman, for example, ARALDITE DY-T; triglycidyl ether of polyoxypropylene glycol, such as those sold under the trade name ARALDITE (RTM) commercially available from Hunstman, for example, ARALDITE DY-L; low viscosity cycloaliphatic epoxy resin, such as those sold under the trade name ARALDITE (RTM) commercially available from Hunstman, for example, ARALDITE CY 184; polymeric epoxy resin based on a dicyclopentadiene backbone, such as those sold under trade name TACTIX (RTM) commercially available from Huntsman, for example, TACTIX 756; glycidyl ester of Versatic (RTM) acid, such as those sold under trade name CARDURA (RTM) commercially available from HEXION, for example, CARDURA E10P.

The coating composition may optionally comprise a further crosslinking material. Suitable further crosslinking materials will be well known to the person skilled in the art.

The further crosslinking material may be a single molecule, a dimer, an oligomer, a (co) polymer or a mixture thereof. The further crosslinking material may be a dimer or trimer.

Examples of suitable further crosslinking materials include, but are not limited to: phenolic resins (or phenol-formaldehyde resins); aminoplast resins (or triazine-formaldehyde resins); amino resins; epoxy-mimic resins, such as those based on bisphenol A (BPA) replacements; isocyanurate resins, such as triglycidylisocyanurate; hydroxy (alkyl) amide resins, such as β-hydroxy (alkyl) amide resins and polyhydroxyalkylamide materials; hydroxy (alkyl) urea resins; carbodiimide resins, such as polycarbodiimide resins; oxazolines; polyamines; polyamides; silanes; silane end-capped polymers; polysiloxanes, such as hydroxyl-functionalised polysiloxanes; polybutadienes; polycaprolactones; polyether polyols; and combinations thereof.

The further crosslinking material may comprise hydroxy (alkyl) amide resins, such as β-hydroxy (alkyl) amide resins and polyhydroxyalkylamide materials, hydroxy (alkyl) urea resins, carbodiimide resins, oxazolines, silanes; silane end-capped polymers; polysiloxanes, such as hydroxyl-functionalised polysiloxanes, polybutadienes, polycaprolactones, polyether polyols or combinations thereof.

The further crosslinking material may comprise hydroxy (alkyl) amide resins, such as β-hydroxy (alkyl) amide resins and polyhydroxyalkylamide materials, silanes; silane end-capped polymers; polysiloxanes, such as hydroxyl-functionalised polysiloxanes, polybutadienes, polycaprolactones or combinations thereof.

Non-limiting examples of phenolic resins are those formed from the reaction of a phenol with an aldehyde or a ketone, such as from the reaction of a phenol with an aldehyde, such as from the reaction of a phenol with formaldehyde or acetaldehyde, or even from the reaction of a phenol with formaldehyde. Non-limiting examples of phenols which may be used to form phenolic resins are phenol, butyl phenol, xylenol and cresol. General preparation of phenolic resins is described in “The Chemistry and Application of Phenolic Resins or Phenoplasts”, Vol V, Part I, edited by Dr Oldring; John Wiley and Sons/Cita Technology Limited, London, 1997. The phenolic resins are of the resol type. By “resol type” is meant resins formed in the presence of a basic (alkaline) catalyst and optionally an excess of formaldehyde. Examples of suitable commercially available phenolic resins include, but are not limited to, those sold under the trade name PHENODUR (RTM) commercially available from Cytec Industries, such as PHENODUR EK-827, PHENODUR VPR1785, PHENODUR PR 515, PHENODUR PR516, PHENODUR PR 517, PHENODUR PR 285, PHENODUR PR612, PHENODUR 520, PHENODUR 307 or PHENODUR PH2024; resins sold under the trade name BAKELITE (RTM) commercially available from Momentive, such as BAKELITE 6582 LB, BAKELITE 6535, BAKELITE PF9989, BAKELITE PF 7295 LB, BAKELITE 6736 LG, BAKELITE 6572 LB or BAKELITE PF6581; SFC 112 commercially available from Schenectady; DUREZ (RTM) 33356 commercially available from SHHPP; Curaphen 40-862 commercially available from Bitrez; BDP2220/DF0181 commercially available from Bitrez; BURNOCK PH2891 commercially available from DIC Corporation; Askofen R⁹⁵⁰⁰ commercially available from Ask Chemicals; or combinations thereof.

Non-limiting examples of aminoplast resins include those which are formed from the reaction of a triazine such as melamine or benzoguanamine with formaldehyde. The resultant compounds may be etherified with an alcohol such as methanol, ethanol, butanol or combinations thereof. The preparation and use of aminoplast resins is described in “The Chemistry and Applications of Amino Crosslinking Agents or Aminoplast”, Vol V, Part II, page 21 ff., edited by Dr Oldring; John Wiley and Sons/Cita Technology Limited, London, 1998. Examples of suitable commercially available aminoplast resins include, but are not limited to, those sold under the tradename MAPRENAL (RTM) such as MAPRENAL MF980, MF 820/60IB or 821/84B commercially available from Prefere Resins and those sold under the tradename CYMEL (RTM) such as CYMEL 303, CYMEL 651E and CYMEL 1128 commercially available from Allnex.

The further crosslinking material may contain nitrogen. The further crosslinking material may be in the form of an amine or amide material. The further crosslinking material may comprise a hydroxyl substituted amine or amide material. The further crosslinking material may comprise a hydroxyalkylamide material, such as a β-hydroxyalkylamide material. Examples of suitable hydroxyalkylamide materials are disclosed in WO 2017/121879, the entire contents of which is incorporated herein by reference, and in particular from page 13, line 4 to page 14, line 11 of WO 2017/121879.

The further crosslinking material may comprise a polyhydroxyalkylamide material, such as a polyhydroxyalkylamide material having the formula (IV):

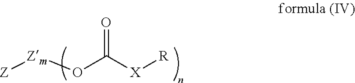

wherein, with reference to formula (IV), Z represents a polymer or an alkylene, alkenylene, alkynylene or arylene group; Z′ represents a bivalent organic linking group; m is 0 or 1; X represents a bivalent organic bridging group; R represents a hydroxyalkylamide group; and n is at least 2. Examples of suitable polyhydroxyalkylamide materials are disclosed in WO2020/123893, the entire contents of which are incorporated herein by reference.

The further crosslinking material may be in the form of a urea material. The further crosslinking material may comprise a hydroxyl substituted urea material. The further crosslinking material may comprise a hydroxy functional alkyl polyurea material.

The further crosslinking material may contain a terminal chemical group as shown in Formula (VII).

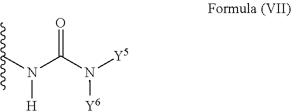

wherein Y⁵ and Y⁶ each, independently, represent hydrogen, an alkyl or a hydroxy functional alkyl having two or more carbon atoms and at least one of Y⁵ and Y⁶ is a hydroxyl functional alkyl having two or more carbon atoms.

The Y⁵ and Y⁶ groups may exclude ether linkages.

The terminal chemical group of Formula (VII) may be connected to a further chemical structure, not shown. Additionally or alternatively, the chemical group of Formula (VII) may be suspended from a carrier substrate, such as a silica carrier substrate, for example.

The further crosslinking material may contain a plurality of terminal chemical groups as shown in Formula (VII). For example, the further crosslinking material may contain 2 to 6 terminal chemical groups as shown in Formula (VII), such as 2, 3 or 4 terminal chemical groups as shown in Formula (VII).

Examples of suitable hydroxy functional alkyl polyureas are disclosed in WO2017/123955, the entire contents of which are incorporated herein by reference, and in particular from paragraph to of WO2017/123955.

The further crosslinking material may be in the form of a carbodiimide resin. The further crosslinking material may comprise a polycarbodiimide. Examples of suitable carbodiimide crosslinker materials are disclosed in WO2017/122171, the entire contents of which are

incorporated herein by reference, and in particular in paragraphs [0005], and to of WO2017/122171.

The further crosslinking material may comprise the reaction product of a reaction mixture comprising:
(i) a cyclic unsaturated acid anhydride and/or diacid derivative thereof;
(ii) an ethylenically unsaturated monomer; and
(iii) an alcohol, amine, thiol and/or water,
   wherein at least a portion of the cyclic unsaturated acid anhydride and/or diacid derivative thereof is reacted with the alcohol, amine, thiol and/or water; and wherein the crosslinking material has an acid number of at least 100 mg KOH/g. Examples of suitable crosslinkers of this type are disclosed in WO 2021/195440, the entire contents of which are incorporated herein by reference, and in particular in paragraphs and to of WO 2021/195440.

The further crosslinking material may comprise the reaction product of a reaction mixture comprising:
(i) ≥70% by weight of a cyclic unsaturated acid anhydride and/or diacid derivative thereof by total solid weight of the monomers from which the crosslinking material is formed;
(ii) optionally, an ethylenically unsaturated monomer;
(iii) and optionally, an alcohol, amine, thiol and/or water,
   wherein at least a portion of the cyclic unsaturated acid anhydride and/or diacid derivate thereof is reacted with the alcohol, amine, thiol and/or water, when present; and wherein the crosslinking material has an acid number of at least 100 mg KOH/g. Examples of suitable crosslinkers of this type are disclosed in WO 2021/195329, the entire contents of which are incorporated herein by reference, and in particular in paragraphs and to of WO 2021/195329.

The further crosslinking material may comprise a silane such as, for example, those sold under the trade name Geniosil (RTM) commercially available from Wacker AG, for example Geniosil GF 93, Geniosil GF 94, Geniosil GF 56, Geniosil GF 91, Geniosil GF 31, Geniosil GF 32 or Geniosil GF 96 or tetraethyl orthosilicate.

The further crosslinking material may comprise a silane end-capped polymer such as, for example, those sold under the trade name VESTANANT (RTM) commercially available from Evonik, for example, VESTANANT EP-M 60 or VESTANANT EP-M 222.

The further crosslinking material may comprise a hydroxyl-functionalised polysiloxanes such as, for example, those sold under the trade name Dowsil (RTM) commercially available from Dow, for example Dowsil RSN-0255 or Dowsil RSN-0233.

The further crosslinking material may comprise polybutadiene, such as, for example, Poly BD HTLP R45 (available from Cray Valley), Poly BD 7001 (available from Cray Valley), Poly BD 700S (available from Cray Valley), Poly BD 605E (available from Cray Valley), Krasol F3000 (available from Cray Valley and/or PB 3600-ID-901 (available from DAICEL Corp.).

The further crosslinking material may comprise polycaprolactone such as, for example, those sold under the trade name Capa (RTM) commercially available from Ingevity, such as Capa 3091, Capa 3022, Capa 3031, Capa 2043, Capa 3050 or Capa 4104.

The further crosslinking material may comprise a polyether polyol such as, for example, those sold under the trade name Desmophen (RTM) commercially available from Covestro, such as Desmophen 2060 BD, Desmophen 1110 BD or Desmophen 1400 BT.

The crosslinking agent and/or further crosslinking material may be substantially free, may be essentially free or may be completely free of formaldehyde. By “substantially free” we mean to refer to a crosslinking agent and/or further crosslinking material containing less than 1000 parts per million (ppm) of any of the compounds or derivatives thereof mentioned above. By “essentially free” we mean to refer to a crosslinking agent and/or further crosslinking material containing less than 100 ppm of any of the compounds or derivatives thereof mentioned above. By “completely free” we mean to refer to a crosslinking agent and/or further crosslinking material containing less than 20 parts per billion (ppb) of any of the compounds or derivatives thereof. The crosslinking agent and/or further crosslinking material may comprise 0 wt % of formaldehyde.

The crosslinking agent may be present in the coating composition in any suitable amount.

The coating compositions may comprise any suitable amount of crosslinking agent. The coating compositions may comprise from 1 to 90 wt %, such as from 5 to 85 wt %, such as from 8 to 80 wt %, such as from 10 to 75 wt %, such as from 12 to 70 wt %, or even from 15 to 60 wt % of the crosslinking agent based on the total solid weight of the coating composition.

The coating composition may comprise at least 1 wt %, such as at least 5 wt %, such as at least 8 wt %, such as at least 10 wt %, such as at least 12 wt %, or even at least 15 wt % of the crosslinking agent based on the total solid weight of the coating composition. The coating composition may comprise up to 90 wt %, such as up to 85 wt %, such as up to 80 wt %, such as up to 75 wt %, such as up to 70 wt %, or even up to 60 wt % of the crosslinking agent based on the total solid weight of the coating composition. The coating composition may comprise from 1 to 90 wt %, such as from 5 to 90 wt %, such as from 8 to 90 wt %, such as from 10 to 90 wt %, such as from 12 to 90 wt %, or even from 15 to 90 wt % of the crosslinking agent based on the total solid weight of the coating composition. The coating composition may comprise from 1 to 85 wt %, such as from 5 to 85 wt %, such as from 8 to 85 wt %, such as from 10 to 85 wt %, such as from 12 to 85 wt %, or even from 15 to 85 wt % of the crosslinking agent based on the total solid weight of the coating composition. The coating composition may comprise from 1 to 80 wt %, such as from 5 to 80 wt %, such as from 8 to 80 wt %, such as from 10 to 80 wt %, such as from 12 to 80 wt %, or even from 15 to 80 wt % of the crosslinking agent based on the total solid weight of the coating composition. The coating composition may comprise from 1 to 75 wt %, such as from 5 to 75 wt %, such as from 8 to 75 wt %, such as from 10 to 75 wt %, such as from 12 to 75 wt %, or even from 15 to 75 wt % of the crosslinking agent based on the total solid weight of the coating composition. The coating composition may comprise from 1 to 70 wt %, such as from 5 to 70 wt %, such as from 8 to 70 wt %, such as from 10 to 70 wt %, such as from 12 to 70 wt %, or even from 15 to 70 wt % of the crosslinking agent based on the total solid weight of the coating composition. The coating composition may comprise from 1 to 60 wt %, such as from 5 to 60 wt %, such as from 8 to 60 wt %, such as from 10 to 60 wt %, such as from 12 to 60 wt % or even from 15 to 60 wt % of the crosslinking agent based on the total solid weight of the coating composition.

The coating composition may comprise from 15 to 60 wt % of the crosslinking agent based on the total solid weight of the coating composition.

The coating composition may comprise any suitable amount of isocyanate material and epoxy material (i.e. the total amount of isocyanate material plus epoxy material in the coating composition. The coating composition may comprise from 1 to 90 wt %, such as from 5 to 85 wt %, such as from 10 to 80 wt %, such as from 20 to 75 wt %, such as from 30 to 70 wt %, or even from 40 to 60 wt % of isocyanate material and epoxy material based on the total solid weight of the coating composition.

The coating composition may comprise at least 1 wt %, such as at least 5 wt %, such as at least 10 wt %, such as at least 20 wt %, or even at least 30 wt % of isocyanate material and epoxy material based on the total solid weight of the coating composition. The coating composition may comprise up to 90 wt %, such as up to 85 wt %, such as up to 80 wt %, such as up to 75 wt %, such as up to 70 wt %, or even up to 60 wt % of isocyanate material and epoxy material based on the total solid weight of the coating composition. The coating composition may comprise from 1 to 90 wt %, such as from 5 to 90 wt %, such as from 10 to 90 wt %, such as from 20 to 90 wt %, such as from 30 to 90 wt %, or even from 40 to 90 wt % of isocyanate material and epoxy material based on the total solid weight of the coating composition. The coating composition may comprise from 1 to 85 wt %, such as from 5 to 85 wt %, such as from 10 to 85 wt %, such as from 20 to 85 wt %, such as from 30 to 85 wt %, or even from 40 to 85 wt % of isocyanate material and epoxy material on the total solid weight of the coating composition. The coating composition may comprise from 1 to 80 wt %, such as from 5 to 80 wt %, such as from 10 to 80 wt %, such as from 20 to 80 wt %, such as from 30 to 80 wt %, or even from 40 to 80 wt % of isocyanate material and epoxy material based on the total solid weight of the coating composition. The coating composition may comprise from 1 to 75 wt %, such as from 5 to 75 wt %, such as from 10 to 75 wt %, such as from 20 to 75 wt %, such as from 30 to 75 wt %, or even from 40 to 75 wt % of isocyanate material and epoxy material based on the total solid weight of the coating composition. The coating composition may comprise from 1 to 70 wt %, such as from 5 to 70 wt %, such as from 10 to 70 wt %, such as from 20 to 70 wt %, such as from 30 to 70 wt %, or even from 40 to 70 wt % of isocyanate material and epoxy material based on the total solid weight of the coating composition. The coating composition may comprise from 1 to 60 wt %, such as from 5 to 60 wt %, such as from 10 to 60 wt %, such as from 20 to 60 wt %, such as from 30 to 60 wt % or even from 40 to 60 wt % of isocyanate material and epoxy material based on the total solid weight of the coating composition.

The coating composition may comprise from 40 to 60 wt % of isocyanate material and epoxy material based on the total solid weight of the coating composition.

The coating composition may comprise any suitable weight ratio of polyamide imide (PAI) resin (a) to crosslinking agent (b). The coating composition may have a weight ratio of (a) to (b) from to 50:1 to 1:10, such as from 10:1 to 1:5, such as from 5:1 to 1:2.

The coating compositions may comprise any suitable amount of isocyanate material. The coating compositions may comprise from 1 to 80 wt %, such as from 5 to 60 wt %, such as from 8 to 50 wt %, such as from 10 to 40 wt % of the isocyanate material based on the total solid weight of the coating composition.

The coating compositions may comprise any suitable amount of epoxy material. The coating compositions may comprise from 1 to 50 wt %, such as from 5 to 40 wt %, such as from 8 to 30 wt %, such as from 10 to 20 wt % of the epoxy material based on the total solid weight of the coating composition

The coating composition may comprise any suitable weight ratio of isocyanate material (a) epoxy material (b). The coating composition may have a weight ratio of (a) to (b) from to 20:1 to 1:20, such as from 10:1 to 1:5, such as from 5:1 to 2:1, or even from 4:1 to 1:1.

The coating composition may be a powder composition or a liquid composition, such as a liquid composition.

When the composition is a liquid composition, the coating composition may comprise a solvent and/or carrier. When the composition is a liquid composition, the coating composition may comprise a powder in a liquid carrier. The powder in a liquid carried may be in the form of a dispersion or slurry, for example.

The coating composition may comprise a single solvent/carrier or a mixture of solvents/carriers. The solvent/carrier may comprise water, an organic solvent/carrier, a mixture of water and an organic solvent/carrier or a mixture of organic solvents/carriers.

The organic solvent/carrier suitably has sufficient volatility to essentially entirely evaporate from the coating composition during the curing process. As a non-limiting example, the curing process may be by heating at 130-300° C. for 1-15 minutes.

Suitable organic solvents/carriers include, but are not limited to the following: aliphatic hydrocarbons such as mineral spirits and high flash point naphtha; aromatic hydrocarbons such as benzene; toluene; xylene; solvent naphtha 100, 150, 200; those available from Exxon-Mobil Chemical Company under the SOLVESSO trade name; alcohols such as ethanol; n-propanol; isopropanol; methoxy propanol; and n-butanol; ketones such as acetone; cyclohexanone; methylisobutyl ketone; methyl ethyl ketone; esters such as ethyl acetate; butyl acetate; n-hexyl acetate; dibasic esters; butoxyl; glycols such as butyl glycol; glycol ethers such as 1-methoxypropanol; ethylene glycol monomethyl ether; ethylene glycol monobutyl ether; benzyl alcohol mixed with xylene; benzyl acetate; ethyl lactate cyclic carbonates such as propylene carbonate, ethylene carbonate; other suitable polar aprotic solvents such as dimethyl sulphoxide (DMSO), dimethyl formamide (DMF), gamma-butyrolactone, gamma-valerolactone and combinations thereof.

The solvent/carrier may comprise an aprotic solvent. Examples of suitable aprotic solvents include, but are not limited to, dibasic esters, cyclopentanone, acetophenone, propylene carbonate, anisole, cyclohexanone, butyl acetate, ethyl acetate, dimethyl sulfoxide (DMSO), dimethylformamide (DMF), Cyrene (RTM), tetrahydrofuran (THF), 1,4-dioxane, diethyl carbonate, ethyl carbonate, acetonitrile and combinations thereof.

The solvent/carrier, when present, may suitably be used in the coating composition in amounts from 10 to 90 wt %, such as from 20 to 80 wt %, such as from 30 to 70 wt %, such as from 30 to 60 wt %, or even from 30 to 50 wt % based on the total weight of the coating composition.

The coating composition may be substantially free, may be essentially free, or may be completely free of dimethylformamide (DMF). By “substantially free” we mean to refer to coating compositions containing less than 1000 parts per million (ppm) of dimethylformamide (DMF). By “essentially free” we mean to refer to coating compositions containing less than 100 ppm of dimethylformamide (DMF). By “completely free” we mean to refer to coating compositions containing less than 20 parts per billion (ppb) of dimethylformamide (DMF).

The coating composition may be a powder coating composition.

It will be appreciated by a person skilled in the art that when the coating composition is a powder, low boiling point solvents may suitably be used in the method for forming the polyamide imide (PAI) resin. This is because low boiling point solvents may be easier to remove when forming a powder.

When the coating composition is a powder coating composition, the powder coating composition may have any suitable average particle size. The powder coating composition may have an average particle size from 10 to 1,000 microns (μm), such as from 10 to 500 μm, such as from 10 to 250 μm, or even from 10 to 100 μm. Particles having these sizes may be produced by any suitable method. Suitable methods will be well known to a person skilled in the art. Examples of suitable methods include, but are not limited to, cold grinding and sieving methods. The average particle size is a D50 value, being the median value that splits the distribution with half above and half below this size. This value is based on volume and sometimes referred to as Dv50.

The coating composition may comprise titanate material. The titanate material may comprise organic titanate material, such as titanate substituted with organic groups (such as one, two, three or four organic groups). Each organic group in this context may include a substituted or unsubstituted, linear, cyclic or branched C₁ to C₁₂ alkyl, alkenyl, or aryl group.

The titanate material may comprise titanate substituted with organic groups (such as one, two, three or four organic groups), each independently selected from methyl, ethyl, n-propyl, isopropyl, n-butyl, t-butyl, pentyl, hexyl, cyclohexyl.

The titanate material may be selected from the group consisting of tetra n-butyl titanate; tetra iso-propyl titanate; tetra ethyl hexyl titanate; zinc acetate; di butyl tin oxide; butyl stannoic acid; or combinations thereof.

The titanate material may be present in the coating composition in an amount of at least 0.1 wt %, such as at least 0.5 wt %, or even at least 1 wt % based on the total solid weight of the coating composition. The titanate material may be present in the coating composition in an amount of up to than 25 wt %, such as up to 15 wt %, such as up to 10 wt %, or even up to 5 wt % based on the total solid weight of the coating composition.

Where the coating composition is a solid material, such as a powder coating composition, for example, the titanate material may be added to the polyamide imide (PAI) resin in a solvent, then the resulting component dried, thereby capturing the titanate material in the solid coating composition.

The coating compositions may further comprise a catalyst. Any catalyst typically used to catalyse crosslinking reactions between acrylic materials and crosslinking agents may be used. Suitable catalysts will be well known to the person skilled in the art. The catalyst may be a non-metal or a metal catalyst or a combination thereof. Suitable non-metal catalysts include, but are not limited to the following: phosphoric acid; blocked phosphoric acid; phosphatised resins such as, for example, phosphatised epoxy resins and phosphatised acrylic resins; CYCAT (RTM) XK 406 N (commercially available from Allnex); sulfuric acid; sulfonic acid; CYCAT 600 (commercially available from Allnex); NACURE (RTM) 5076 or NACURE 5925 (commercially available from King industries); acid phosphate catalyst such as NACURE XC 235 (commercially available from King Industries); and combinations thereof. Suitable metal catalysts will be well known to the person skilled in the art. Suitable metal catalysts include, but are not limited to the following: tin containing catalysts, such as monobutyl tin tris(2-ethylhexanoate); zirconium containing catalysts, such as KKAT (RTM) 4205 (commercially available from King Industries); titanate based catalysts, such as tetrabutyl titanate TnBT (commercially available from Sigma Aldrich); and combinations thereof.

The catalyst, when present, may be used in the coating composition in any suitable amount. The catalyst, when present, may be used in amounts from 0.001 to 10 wt %.

The coating compositions may comprise a further resin material. Suitable further resin materials will be well known to a person skilled in the art. Suitable examples of further resin materials include, but are not limited to the following: polyester resins; acrylic resins; polyvinyl chloride (PVC) resins; alkyd resins; polyurethane resins; polysiloxane resins; epoxy resins or combinations thereof.

The coating compositions may comprise other optional materials well known in the art of formulating coatings, such as colorants, plasticizers, abrasion-resistant particles, anti-oxidants, hindered amine light stabilizers, UV light absorbers and stabilizers, surfactants, flow control agents, thixotropic agents, fillers, organic co-solvents, reactive diluents, catalysts, grind vehicles, lubricants, waxes and other customary auxiliaries.

As used herein, the term “colorant” means any substance that imparts colour and/or other opacity and/or other visual effect to the composition. The colorant can be added to the coating composition in any suitable form, such as discrete particles, dispersions, solutions and/or flakes. A single colorant or a mixture of two or more colorants can be used in the coatings of the present invention. Suitable colorants are listed in U.S. Pat. No. 8,614,286, column 7, line 2 through column 8, line 65, which is incorporated by reference herein. Particularly suitable for packaging coatings are those approved for food contact, such as titanium dioxide; iron oxides, such as black iron oxide; aluminium paste; aluminium powder such as aluminium flake; carbon black; ultramarine blue; phthalocyanines, such as phthalocyanine blue and phthalocyanine green; chromium oxides, such as chromium green oxide; graphite fibrils; ferried yellow; quindo red; and combinations thereof, and those listed in Article 178.3297 of the Code of Federal Regulations, which is incorporated by reference herein.

The colorant, when present, may be used in the coating composition in any suitable amount. The colorant, when present, may be used in the coating composition in amounts up to 90 wt %, such as up to 50 wt %, or even up to 10 wt % based on the total solid weight of the coating composition.

Suitable lubricants will be well known to the person skilled in the art. Suitable examples of lubricants include, but are not limited to the following: carnauba wax and polyethylene type lubricants. The lubricant, when present, may be used in the coating composition in amounts of at least 0.01 wt % based on the total solid weight of the coating composition.

Surfactants may optionally be added to the coating composition in order to aid in flow and wetting of the substrate. Suitable surfactants will be well known to the person skilled in the art. The surfactant, when present, may be chosen to be compatible with food and/or beverage container applications or aerosol applications, suitably, aerosol applications. Suitable surfactants include, but are not limited to the following: alkyl sulphates (e.g., sodium lauryl sulphate); ether sulphates; phosphate esters; sulphonates; and their various alkali, ammonium, amine salts; aliphatic alcohol ethoxylates; alkyl phenol ethoxylates (e.g. nonyl phenol polyether); salts and/or combinations thereof. The surfactants, when present, may be present in amounts from 0.01 wt % to 10 wt %, suitably from 0.01 to 5 wt %, such as from 0.01 to 2 wt % based on the total solid weight of the coating composition.

The coating compositions are substantially free of pyrrolidone solvents. The pyrrolidone solvent may comprise any solvent containing a pyrrolidone moiety, such as, for example, N-methyl-2-pyrrolidone (NMP), N-methyl-3-pyrrolidone, N-ethyl-2-pyrrolidone, N-ethyl-3-pyrrolidone, N-propyl-2-pyrrolidone, N-propyl-3-pyrrolidone, N-butyl-2-pyrrolidone, N-butyl-3-pyrrolidone, N-benzyl-2-pyrrolidone, N-benzyl-3-pyrrolidone, 2-pyrrolidone and combinations thereof. The coating compositions may be essentially free or may be completely free of pyrrolidone solvents such as N-methyl-2-pyrrolidone (NMP). The pyrrolidone solvents mentioned above may not be added to the composition intentionally but may be present in trace amounts because of unavoidable contamination from the environment. By “substantially free” we mean to refer to coating compositions containing less than 1000 parts per million (ppm) of any of the pyrrolidone solvents mentioned above. By “essentially free” we mean to refer to coating compositions containing less than 100 ppm of any of the pyrrolidone solvents mentioned above. By “completely free” we mean to refer to coating compositions containing less than 20 parts per billion (ppb) of any of the pyrrolidone solvents mentioned above.

Advantageously, the polyamide imide (PAI) resins of the present invention may be synthesised without the need for pyrrolidone solvents. Thus, advantageously, the coating compositions of the present invention are substantially free of pyrrolidone solvents.

The coating compositions may be substantially free of bisphenol A (BPA) and derivatives thereof. The coating compositions may be essentially free or may be completely free of bisphenol A (BPA) and derivatives thereof. Derivatives of bisphenol A include, for example, bisphenol A diglycidyl ether (BADGE). The coating compositions according to the present invention may also be substantially free of bisphenol F (BBF) and derivatives thereof. The coating compositions may be essentially free or may be completely free of bisphenol F (BPF) and derivatives thereof. Derivatives of bisphenol F include, for example, bisphenol F diglycidyl ether (BPFG). The compounds or derivatives thereof mentioned above may not be added to the composition intentionally but may be present in trace amounts because of unavoidable contamination from the environment. By “substantially free” we mean to refer to coating compositions containing less than 1000 parts per million (ppm) of any of the compounds or derivatives thereof mentioned above. By “essentially free” we mean to refer to coating compositions containing less than 100 ppm of any of the compounds or derivatives thereof mentioned above. By “completely free” we mean to refer to coating compositions containing less than 20 parts per billion (ppb) of any of the compounds or derivatives thereof.

The coating compositions may be substantially free, essentially free or may be completely free of dialkyltin compounds, including oxides or other derivatives thereof. Examples of dialkyltin compounds include, but are not limited to the following: dibutyltindilaurate (DBTDL); dioctyltindilaurate; dimethyltin oxide; diethyltin oxide; dipropyltin oxide; dibutyltin oxide (DBTO); dioctyltinoxide (DOTO) or combinations thereof. By “substantially free” we mean to refer to coating compositions containing less than 1000 parts per million (ppm) of any of the compounds or derivatives thereof mentioned above. By “essentially free” we mean to refer to coating compositions containing less than 100 ppm of any of the compounds or derivatives thereof mentioned above. By “completely free” we mean to refer to coating compositions containing less than 20 parts per billion (ppb) of any of the compounds or derivatives thereof.

The coating compositions may be substantially free, may be essentially free or may be completely free of bromine. By “substantially free” we mean to refer to coating compositions containing less than 1000 parts per million (ppm) of bromine. By “essentially free” we mean to refer to coating compositions containing less than 100 ppm of bromine. By “completely free” we mean to refer to coating compositions containing less than 20 parts per billion (ppb) of bromine.

The coating compositions may be prepared by any suitable method. For example, the coating compositions may be prepared by first dry blending the polyamide imide (PAI) resin, the crosslinking agent and, if present, pigment and/or filler, curing agent and additives in a blender. The blender may be operated for any suitable period of time. The blender may be operated for a period of time sufficient to result in a homogeneous dry blend of the materials charged thereto. The homogenous dry blend may then be melt blended in an extruder, such as a twin-screw co-rotating extruder, operated within a temperature range from 80 to 140° C., suitably from 100 to 125° C. The extrudate of the coating composition may be cooled and is typically milled to an average particle size as described above.

The coating composition may be a curable coating composition. “Curable coating compositions” and like terms as used herein, refers to coating compositions that have an initial liquid or powder state and a final state in which the coating composition has been transformed into a substantially continuous, coalesced state.

Thus, there is provided a method of making a metal package having a coating on at least a portion thereof, the method comprising the steps of:
i) applying a coating composition comprising a polyamide imide resin (PAI) and a crosslinking agent comprising an isocyanate material and an epoxy material, wherein the coating composition is substantially free of pyrrolidone solvents to at least a portion of the metal package; and
ii) curing the coating composition to form a coating.

The coating composition may be cured by any suitable method. The coating composition may be cured by heat curing or by chemical curing.

The coating composition may be cured by heat curing. The coating composition, when heat cured, may be cured at any suitable temperature. The coating composition, when heat cured, may be cured at temperatures from 120 to 300° C., such as from 140 to 280° C., such as from 160 to 260° C., such as from 180 to 240° C., or even from 180 to 220° C.

The coating composition may be cured at a temperature from 150 to 240° C.

The coating composition may be cured at a temperature from 180 to 220° C.

The coating composition may be cured at a temperature from 180 to 200° C.

Advantageously, the coating compositions of the present invention can be cured at lower temperatures than would typically be expected.

The coating compositions are applied to a package (which may herein be described interchangeably as a substrate).

The coating compositions may be applied to the substrate, or a portion thereof, as a single layer or as part of a multi layer system. The coating composition may be applied as a single layer. The coating compositions may be applied to an uncoated substrate. For the avoidance of doubt an uncoated substrate extends to a surface that is cleaned prior to application. The coating compositions may be applied on top of another paint layer as part of a multi layer system. For example, the coating composition may be applied on top of a primer. The coating compositions may form an intermediate layer or a top coat layer. The coating composition may be applied as the first coat of a multi coat system. The second, third, fourth etc. coats may comprise any suitable paint such as those containing, for example, epoxy resins; polyester resins; polyurethane resins; polysiloxane resins; hydrocarbon resins or combinations thereof. The second, third, fourth etc. coats may comprise polyester resins. The second, third, fourth etc. coats may be a liquid coating or a powder coating, suitably a powder coating.

The coating compositions may be applied on top of a primer.

The coating compositions may be applied to a substrate once or multiple times.

The coating compositions may be applied to any suitable substrate. The substrate may be formed of metal, plastic, composite and/or wood. The substrate may be a metal substrate.

Suitable metals include, but are not limited to, the following: steel; tinplate; tinplate pre-treated with a protective material such as chromium, titanium, titanate or aluminium; tin-free steel (TFS); galvanised steel, such as for example electro-galvanised steel; aluminium; aluminium alloy; and combinations thereof.

The metal may be aluminium, aluminium alloy, or combinations thereof.

Examples of suitable metal substrates include, but are not limited to, food and/or beverage packaging, components used to fabricate such packaging or monobloc aerosol cans and/or tubes.

The food and/or beverage packaging may be a can. Examples of cans include, but are not limited to, two-piece cans, three-piece cans and the like. Suitable examples of monobloc aerosol cans and/or tubes include, but are not limited to, deodorant and hair spray containers. Monobloc aerosol cans and/or tubes may be aluminium monobloc aerosol cans and/or tubes.

The substrate may be a food and/or beverage packaging or component used to fabricate such packaging.

The substrate may be a monobloc aerosol can and/or tube.

The application of various pre-treatments and coatings to packaging is well established. Such treatments and/or coatings, for example, can be used in the case of metal cans, wherein the treatment and/or coating is used to retard or inhibit corrosion, provide a decorative coating, provide ease of handling during the manufacturing process, and the like. Coatings can be applied to the interior of such cans to prevent the contents from contacting the metal of the container. Contact between the metal and a food or beverage, for example, can lead to corrosion of a metal container, which can then contaminate the food or beverage. This is particularly true when the contents of the can are acidic in nature. The coatings applied to the interior of metal cans also help prevent corrosion in the headspace of the cans, which is the area between the fill line of the product and the can lid; corrosion in the headspace is particularly problematic with food products having a high salt content. Coatings can also be applied to the exterior of metal cans.

The coating compositions may be applied to coiled metal stock, such as the coiled metal stock from which the ends of cans are made (“can end stock”), and end caps and closures are made (“cap/closure stock”). Since coatings designed for use on can end stock and cap/closure stock are typically applied prior to the piece being cut and stamped out of the coiled metal stock, they are typically flexible and extensible. For example, such stock is typically coated on both sides. Thereafter, the coated metal stock is punched. For can ends, the metal is then scored for the “pop-top” opening and the pop-top ring is then attached with a pin that is separately fabricated. The end is then attached to the can body by an edge rolling process. A similar procedure is done for “easy open” can ends. For easy open can ends, a score substantially around the perimeter of the lid allows for easy opening or removing of the lid from the can, typically by means of a pull tab. For caps and closures, the cap/closure stock is typically coated, such as by roll coating, and the cap or closure stamped out of the stock; it is possible, however, to coat the cap/closure after formation. Coatings for cans subjected to relatively stringent temperature and/or pressure requirements should also be resistant to popping, corrosion, blushing and/or blistering.

The substrate may be a package coated at least in part with any of the coating compositions described herein. A “package” is anything used to contain another item, particularly for shipping from a point of manufacture to a consumer, and for subsequent storage by a consumer. A package will be therefore understood as something that is sealed so as to keep its contents free from deterioration until opened by a consumer. The manufacturer will often identify the length of time during which the food or beverage will be free from spoilage, which typically ranges from several months to years. Thus, the present “package” is distinguished from a storage container or bakeware in which a consumer might make and/or store food; such a container would only maintain the freshness or integrity of the food item for a relatively short period. A package according to the present invention can be made of metal or non-metal, for example, plastic or laminate, and be in any form. An example of a suitable package is a laminate tube. Another example of a suitable package is metal can. The term “metal can” includes any type of metal can, container or any type of receptacle or portion thereof that is sealed by the food and/or beverage manufacturer to minimize or eliminate spoilage of the contents until such package is opened by the consumer. One example of a metal can is a food can; the term “food can(s)” is used herein to refer to cans, containers or any type of receptacle or portion thereof used to hold any type of food and/or beverage. The term “metal can(s)” specifically includes food cans and also specifically includes “can ends” including “E-Z open ends”, which are typically stamped from can end stock and used in conjunction with the packaging of food and beverages. The term “metal cans” also specifically includes metal caps and/or closures such as bottle caps, screw top caps and lids of any size, lug caps, and the like. The metal cans can be used to hold other items as well, including, but not limited to, personal care products, bug spray, spray paint, and any other compound suitable for packaging in an aerosol can. The cans can include “two piece cans” and “three-piece cans” as well as drawn and ironed one-piece cans; such one piece cans often find application with aerosol products. Packages coated according to the present invention can also include plastic bottles, plastic tubes, laminates and flexible packaging, such as those made from PE, PP, PET and the like. Such packaging could hold, for example, food, toothpaste, personal care products and the like.

The coating compositions can be applied to the interior and/or the exterior of the package. The coating compositions could also be applied as a rim coat to the bottom of the can. The rim coat functions to reduce friction for improved handling during the continued fabrication and/or processing of the can. The coating compositions can also be applied to caps and/or closures; such application can include, for example, a protective varnish that is applied before and/or after formation of the cap/closure and/or a pigmented enamel post applied to the cap, particularly those having a scored seam at the bottom of the cap. Decorated can stock can also be partially coated externally with the coating described herein, and the decorated, coated can stock used to form various metal cans.

Metal coils, having wide application in many industries, are also substrates that can be coated according to the present invention. Coil coatings also typically comprise a colorant.

The coating compositions of the present invention may be applied to at least a portion of the substrate. For example, when the coating compositions are applied to a food and/or beverage can, the coating compositions may be applied to at least a portion of an internal and/or external surface of said food and/or beverage can. For example, when the coating compositions are applied to a food and/or beverage can, the coating compositions may be applied to at least a portion of an internal surface of said food and/or beverage can.

The coating composition may be applied as a repair coating for component parts of food and beverage cans. For example, as a repair coating for a full aperture easy open end for food cans. This end component may repair coated, after fabrication, by airless spraying of the material on to the exterior of the score line. Other uses as repair coatings include the coating of seams and welds, such as side seams for which the coating may be applied to the area by spraying (airless or air driven) or roller coating. Repair coating can also include protection of vulnerable areas where corrosion may be likely due to damage, these areas include flanges, rims and bottom rims where the coating may be applied by spraying, roller coating flow or dip coating.

The coating compositions of the present invention may be applied to the substrate by any suitable method. Methods of applying the coating compositions of the present invention will be well known to a person skilled in the art. Suitable application methods for the coating compositions of the present invention include, but are not limited to the following: electrocoating such as electrodeposition; spraying; electrostatic spraying; dipping; rolling; brushing; and the like. The coating compositions of the present invention may be applied to the substrate by spraying. Thus, the coating compositions of the present invention may be a spray composition. For the avoidance of doubt, by the term ‘spray composition’ and like terms as used herein is meant, unless specified otherwise, that the coating is suitable to be applied to a substrate by spraying, i.e. is sprayable.

As used herein, unless otherwise expressly specified, all numbers such as those expressing values, ranges, amounts or percentages may be read as if prefaced by the word “about”, even if the term does not expressly appear. Also, the recitation of numerical ranges by endpoints includes all integer numbers and, where appropriate, fractions subsumed within that range (e.g. 1 to 5 can include 1, 2, 3, 4 when referring to, for example, a number of elements, and can also include 1.5, 2, 2.75 and 3.80, when referring to, for example, measurements). The recitation of end points also includes the end point values themselves (e.g. from 1.0 to 5.0 includes both 1.0 and 5.0). Any numerical range recited herein is intended to include all sub-ranges subsumed therein.

Singular encompasses plural and vice versa. For example, although reference is made herein to “a” polyamide imide (PAI) resin, “a” crosslinking agent, “an” imide containing moiety, “an” acid group, “an” alcohol group, and the like, one or more of each of these and any other components can be used. As used herein, the term “polymer” refers to oligomers and both homopolymers and copolymers, and the prefix “poly” refers to two or more.

The terms “comprising”, “comprises” and “comprised of” as used herein are synonymous with “including”, “includes” or “containing”, “contains”, and are inclusive or open-ended and do not exclude additional, non-recited members, elements or method steps. Additionally, although the present invention has been described in terms of “comprising”, the coating compositions detailed herein may also be described as “consisting essentially of” or “consisting of”.

As used herein, the term “and/or,” when used in a list of two or more items, means that any one of the listed items can be employed by itself or any combination of two or more of the listed items can be employed. For example, if a list is described as comprising group A, B, and/or C, the list can comprise A alone; B alone; C alone; A and B in combination; A and C in combination, B and C in combination; or A, B, and C in combination.

All of the features contained herein may be combined with any of the above aspects in any combination.

For a better understanding of the invention, and to show how embodiments of the same may be carried into effect, reference will now be made, by way of example, to the following examples.

### Examples

### Polyamide Imide (PAI) Example 1

PAI Example 1 was produced according to the following method. To a reaction vessel equipped with heating, stirrer, reflux condenser and nitrogen sparge was added 50.6 grams (g) propylene carbonate, 26.2 g methylene diphenyl 4,4′diisocyanate (Desmodur 44 MC1 commercially available from Bayer Material Science AG) and 11.31 g trimellitic anhydride. The mixture was heated, with stirring, to 120° C. and held at this temperature for 150 minutes. After this time, 5.36 g para-tertbutyl benzoic acid, 6.22 g 4-methyl tetrahydrophthalic anhydride and 4.17 g 2,2,4-trimethyl pentane 1,3 diol were added to the reaction mixture. The reaction mixture was then held at 120° C. for a further 150 minutes. When the acid value of the resin reached 50 mg KOH/g (based on solids), the reaction mixture was cooled to 80° C. and 12.65 g isopropanol was added.

The resultant mixture was filtered. The resultant resin had a solids content of 40 wt % and an acid value of 50 mg KOH/g.

The gel time of PAI Example 1 was 39 seconds at 180° C. and 23 seconds at 200° C. as measured on a Coesfield GT Material Tester according to the following method: five drops of the resin solution were added to a heated well which was pre-heated to the test temperature of 180° C. or 200° C. As soon as all of the drops had been added to the well, a stopwatch was started and the sample was stirred vigorously. The gel-time was determined as the time required for the sample to reach a gel-like state (as determined visually).

### PAI Example 2

PAI Example 2 was produced according to the following method. To a reaction vessel equipped with heating, stirrer, reflux condenser and nitrogen sparge was added 11.31 g trimellitic anhydride (TMA), 26.2 g ethylene diphenyl diisocyanate (MDI), 34.83 g propylene carbonate. The mixture was heated, with stirring, to 120° C. and held at this temperature for 150 minutes. After this time, 5.36 g para-tertbutyl benzoic acid (PTBBA), 6.22 g methyl tetrahydrophthalic acid (MTHPA) and 4.17 g trimethylpentanediol (TMPD) were added to the reaction mixture. The reaction mixture was then held at 120° C. for a further 150 minutes. When the acid value of the resin reached about 50 mg KOH/g (based on solids), the reaction mixture was cooled to 80° C. and 11.91 g benzyl alcohol was added.

The resultant mixture was filtered. The resultant resin had a solids content of 55 wt % and an acid value of 53 mg KOH/g.

The gel time of PAI Example 2 was 34 seconds at 180° C. and 25 seconds at 200° C. according to the method described above.

### PAI Example 3

PAI Example 3 was produced according to the same method as described above for PAI Example 3 with the exception that 14.06 g benzyl alcohol was added in the final step instead of 12.65 g isopropanol.

The resultant resin had a solids content of 45 wt % and an acid value of 50 mg KOH/g.

The gel time of PAI-Example 3 was 29 seconds at 180° C. and 18 seconds at 200° C. according to the method described above.

### PAI Example 4

PAI-Example 3 was formed from 19 grams (g) trimellitic anhydride (TMA), 33 g methylene diphenyl diisocyanate (MDI), 6 g para-tertbutyl benzoic acid (PTBBA), 30 g propylene carbonate and 15 g dimethylsulphoxide (DMSO). The mixture was heated for six hours at 120° C. at reflux.

The resultant mixture was filtered. The resultant resin had a solids content of 45 wt % and an acid value of 43 mg KOH/g.

### PAI Example 5

PAI-Example 5 was formed from 76 grams (g) trimellitic anhydride (TMA), 70 g hexamethylene diisocyanate (HDI), 82 g methylene diphenyl diisocyanate (MDI), 36 g para-tertbutyl benzoic acid (PTBBA) and 220 g propylene carbonate. The mixture was heated for three hours at 135° C. at reflux. After this time, 20 g benzyl alcohol was added to the mixture. The resultant mixture was filtered. The resultant resin had a solids content of 37.6 wt % and an acid value of 38 mg KOH/g.

### PAI Example 6

PAI-Example 6 was formed from 76 grams (g) trimellitic anhydride (TMA), 176 g methylene diphenyl diisocyanate (MDI),36 g para-tertbutyl benzoic acid (PTBBA), 28 g trimethylpentanediol (TMPD) and 220 g propylene carbonate. The mixture was heated for eight hours at 125° C. at reflux. After this time, 81 g isopropyl alcohol was added. The final product was then dissolved in 274 g propyl carbonate. The resultant mixture was filtered. The resultant resin had a solids content of 31.9 wt % and an acid value of 46 mg KOH/g.

### Coating Composition Examples 1 to 6

Coating Composition Examples 1 to 6 were prepared according to the formulations in Table 1. All amounts are given in grams unless specified otherwise.

### Comparative Coating Examples 1 to 6

Comparative Coating Composition Examples 1, 2, 3, 5 and 6 were prepared according to the formulations in Table 2. All amounts are given in grams unless specified otherwise.

Comparative Coating Composition Example 4 is a 2 coating composition containing no crosslinkers and 72 wt % Resistherm AL 336 (a commercial polyamide imide resin supplied as 36% solids in a N-methyl-2-pyrrolidone: xylene solution (45.8:18.2) from Allnex).

The coatings were tested according to the following test methods. Results are shown in Tables 3-5.

### Test Methods

MEK rub test: 100 reciprocating rubs were carried out using a 1 kg hammer covered with a double cotton cloth layer soaked in methyl ethyl ketone. The coated parts of panels or cans were then tested for scratch resistance. After the 100 reciprocating rubs were carried out the cotton wool is checked for colouration.

Scratch resistance: a sharp-edged plastic device was moved along the panel and can surface at an angle of 45°. The scratch resistance was evaluated to the level of peeling from the substrate and using a rating of 1-5, with 5 being the best.

Test panel preparation: The coating samples were applied onto aluminium panels monobloc cans. 1-2 grams of coating compositions 1-6 and comparative coating compositions 1-4 were applied individually onto aluminium panels by coating with a doctor knife. Subsequently the coated panel was placed in a drying cabinet be cured for 4 minutes at a temperature as described for each composition.

Test can preparation: Some chosen samples of coating composition 1-6 and comparative coating compositions 1-6 were applied into aluminium cans by controlled running down of the varnish for a defined time to obtain film a film thickness between 9-13 μm. Each can contains 0.6-1.2 grams of varnish to apply this coating procedure. Subsequently the cans were placed in a convection oven (always 4 cans together to control the heat flow) for 4 min at a temperature described for each sample.

Gel time: the gel time was measured on a Coesfield GT Material Tester according to the following method. Five drops of the resin solution were added to a heated well which was pre-heated to the test temperature. As soon as all of the drops had been added to the well, a stopwatch was started and the sample was stirred vigorously. The gel-time was determined as the time required for the sample to reach a gel-like state (as determined visually).

Wedge-bend test: A 4×14 cm strip is cut from a painted aluminium sheet (see Test panel preparation). This cut-out section is then bent in the middle of the transverse edge so that the painted area points outwards. The now curved substrate is placed on a bevelled anvil in a drop tower, in which a 2300 g heavy hammer is located at a height of 65 cm. The weight ensures the conical deformation of the test strip (wedge bend) when it hits the substrate.

To make the damage more recognizable, the Wedge Bend sheet is placed in an aqueous copper (II) sulfate (CuSO₄) hydrochloric acid (HCl) solution for 2 min. Due to the imperfections in the paint, the aluminium substrate is unprotected, which means that the aluminium can react with the CuSO₄—HCl solution.

The resulting damage is divided into “cracks” (continuous, coherent defects) and “peppering” (punctiform defects). The length of the defective lacquer layer is a characteristic value and is given in millimetres, and the shorter the defective lacquer layer, the more flexible the lacquer.

Impact test: The impact test was carried our according to ASTM D2794. The coated side of the panel facing up (direct) and down (reverse) on a metal fixture. A 1 kg weight is dropped from 60 cm height and strikes an indentation. The bottom part of the coated can was cut at a height of 20 mm and the coated side facing down on a Teflon coated fixture. A 1 kg weight is dropped from a height of 1 meter to strike an indentation. The integrity of the coating was measured using a WACO Enamel Rater Instrument and a 1% salt solution containing 0.1% dioctyl sodium sulfosuccinate and reported in milliamperes (mA).

Coating thickness: Coating thickness was measured according to a non-destructive measurement of thermoset coatings applied onto an aluminium base, using the ETAOPTIK (Fluke) coating thickness measuring instrument. The uncoated aluminium panel and cans was measured both on the side wall and on the bottom of the can. The measured thickness was reported in microns and represented either the average of 10 measurements of the lowest and highest values.

Boiling water tests: The coated parts of the panel and the can were immersed in boiling demineralized water at 100° C. for 15 min and subsequently removed and dried. They were then tested for cross hatch adhesion, cutting edge adhesion, blush, scratch resistance, crazing after folding and adhesion after folding.

Cross cut adhesion: cross cut adhesion was measured according to the DIN ISO 2409 standard. Briefly, a crosshatch grid was made in the film using a grid comb and then covered with tape (grade TESA 4104 clear). The tape was applied to the film surface with a bit finger pressure in order to ensure a homogenous attachment of the tape to the scratched film surface. Within 60 seconds of its application, the tape was removed rapidly. The grid area is then checked for removal of the coating from the substrate. The grid area is then checked for removal of the coating from the substrate. The adhesion was scored in accordance with the following scale:
Gt0: The edges of the cuts are completely smooth. No brims along the hole grid are visible, none of the squares of the grid are detached.
Gt1: Small flakes of the coating are detached at intersections; less than 5% of the area is affected.
Gt2: Some flakes of the coating are detached along the edges and/or intersections of the incisions. The area affected is 5-15% of the grid.
Gt3: The coating has peeled along the edges and on parts of the squares of the grid. The area affected is 15-35% of the grid
Gt4: The coating has peeled along the edges of the incisions in large strips and some squares are totally detached. The area affected is 35-65% of the grid.
Gt5: All degrees of peeling and flecking that can be not classified under 4.

Cutting edge adhesion: The coated parts of the panel and can were cut along the length of the panel and can using scissors. The cutting edge adhesion was evaluated according to the level of peeling from the substrate and using a rating 1-5 with 5 being the best.

Blush: The coated parts of the tested panel and can were compared with the untested control sample. The blush was evaluated by using a rating of 1-5, with 5 the best.

Crazing after folding: The coated parts of the panel and can were folded by an angle of 180°. The folded area was inspected visually. The crazing was evaluated by using a rating of 1-5, with 5 being the best.

Adhesion after folding: The coated parts of the panel and can were folded by an angle of 180°. The folded area was scratched by hand. The adhesion was evaluated by using a rating from 1-5, with 5 being the best.

TABLE 1
Formulation of Coating Examples 1 to 6

| | Coating | Coating | Coating | Coating | Coating | Coating |
|---|---|---|---|---|---|---|
| Component | Example 1 | Example 2 | Example 3 | Example 4 | Example 5 | Example 6 |
| PAI-Example 1 | 8.00 | 8.00 | 8.00 | 8.00 | — | — |
| PAI-Example 2 | — | — | — | — | 8.00 | 8.00 |
| Desmodur PL 350 ¹ | 2.86 | 2.86 | 2.86 | 1.43 | 1.43 | 1.43 |
| Araldite DY-C ² | 1.14 | 1.14 | 0.85 | 0.57 | 0.85 | 1.18 |
| CHDM 6 EO ³ | — | — | 1.11 | — | — | — |
| RP-45 ⁴ | 2.00 | 2.00 | 2.00 | 2.00 | 2.00 | 2.00 |
| Byk LP-g 23116 ⁵ | 0.06 | 0.06 | 0.06 | 0.06 | 0.06 | 0.06 |
| K-Kat XK 672 ⁶ | — | — | — | 0.03 | 0.03 | 0.03 |
| Tyzor TNBT ⁷ | — | 1.41 | — | — | — | — |

¹ blocked aliphatic polyisocyanate based on HDI available from Covestro
² diglycidyl ether of cyclohexane dimethanol available from Huntsman
³ cyclohexane dimethanol available from Arkema
⁴ solvent blend formed from 45.9 g benzyl alcohol, 43.8 g ethyl acetate, 7.56 g propylene carbonate and 37.8 g Solvesso 100 (available from Exxon-Mobil Chemical Company).
⁵ additive available from BYK
⁶ catalyst available from King Industries
⁷ (tetra-n-butyl titanate) 10 wt % in cyclopentanone from Dorf Ketal

TABLE 2
Formulation of Comparative Examples 1-3, 5 and 6

| | Comparative | Comparative | Comparative | Comparative | Comparative |
|---|---|---|---|---|---|
| | Coating | Coating | Coating | Coating | Coating |
| Component | Example 1 | Example 2 | Example 3 | Example 5 | Example 6 |
| PAI-Example 1 | — | — | 8.00 | 8.00 | 8.00 |
| PAI-Example 2 | 8.00 | — | — | — | — |
| PAI-Example 3 | — | 8.00 | — | — | — |
| Desmodur PL 350 ¹ | — | 1.43 | — | — | — |
| Tolonate D2 ² | 1.39 | — | — | — | — |
| Desmodur PL 340 ³ | — | | 2.06 | — | — |
| Araldite DY-C ⁴ | — | — | — | 1.14 | 1.14 |
| RP-45 ⁵ | 2.00 | 2.00 | 2.00 | 2.00 | 2.00 |
| BYK LP-G 23116 ⁶ | 0.06 | 0.06 | 0.06 | 0.06 | 0.06 |
| K-Kat XK 672 ⁷ | — | — | — | 0.06 | — |

¹ blocked aliphatic polyisocyanate based on HDI available from Covestro
² aliphatic MEKO-blocked polyisocyanate prepolymer based on HDI from Vencorex
³ blocked aliphatic polyisocyanate based on HDI available from Covestro
⁴ diglycidyl ether of cyclohexane dimethanol available from Huntsman
⁵ solvent blend formed from 45.9 g benzyl alcohol, 43.8 g ethyl acetate, 7.56 g propylene carbonate and 37.8 g Solvesso 100 (available from Exxon-Mobil Chemical Company).
⁶ additive available from BYK
⁷ catalyst available from King Industries

TABLE 3
MEK resistance test of Coating Examples 1 to 6 and Comparative Example 4
MEK resistance

| | | | | | | | Comparative |
|---|---|---|---|---|---|---|---|
| RDS20, | Coating | Coating | Coating | Coating | Coating | Coating | Coating |
| 4′180° C. | Example 1 | Example 2 | Example 3 | Example 4 | Example 5 | Example 6 | Example 4 |
| MEK Double | 200 | 100 | 100 | 100 | 100 | 100 | 100 |
| Rubs | | | | | | | |
| Comment | Not | Not | Not | Not | Not | Not | Scratchable |
| | scratchable | scratchable | scratchable | scratchable | scratchable | scratchable | |

TABLE 4
Wedge-Bend test of Coating Composition 1 to 6 and Comparative Examples 1 to 6.
Wedge-Bend

| | | Coating | Coating | | Coating | | | Comparative |
|---|---|---|---|---|---|---|---|---|
| | | Example | Example | Coating | Example | Coating | Coating | Coating |
| | | 1 | 2 | Example 3 | 4 | Example 5 | Example 6 | Example 1 |
| RDS20, | measurement | 7 | 31 | 29 | 15 | 57 | 9 | 72 |
| 4′180° C. | 1/mm | | | | | | | |
| | measurement | 14 | 30 | 26 (34 | 21 | 60 | 9 | 72 |
| | 2/mm | | | Peppering) | | | | |
| | mean | 11 | 31 | 28 (34 | 18 | 59 | 3 | 72 |
| | value | | | Peppering) | | | | |
| RDS20, | measurement | — | — | 35 (43 | 56 | 22 | 37 | 35 (cracking |
| 4′200° C. | 1/mm | | | Peppering) | | | | up to 75) |
| | measurement | — | — | 35 | 60 | 22 (28 | 24 (44 | 74 |
| | 2/mm | | | | | peppering) | peppering) | |
| | mean | — | — | 35 (43 | 58 | 22 (28 | 28 (44 | 74 |
| | value | | | Peppering) | | peppering) | peppering) | |

| | | Comparative | Comparative | Comparative | Comparative | Comparative |
|---|---|---|---|---|---|---|
| | | Coating | Coating | Coating | Coating | Coating |
| | | Example 2 | Example 3 | Example 4 | Example 5 | Example 6 |
| RDS20, | measurement | 72 | 66 | 12 | 80 | 77 |
| 4′180° C. | 1/mm | | | | | |
| | measurement | 74 | 74 | 16 | 80 | 75 |
| | 2/mm | | | | | |
| | mean | 73 | 70 | 14 | 80 | 76 |
| | value | | | | | |
| RDS20, | measurement | 75 | 64(75 | 9 | — | — |
| 4′200° C. | 1/mm | | peppering) | | | |
| | measurement | 75 | 67 (75 | 10 | — | — |
| | 2/mm | | peppering) | | | |
| | mean | 75 | 66 (75 | 10 | — | — |
| | value | | peppering) | | | |

TABLE 5
Boiling water tests of Coating Examples 1 to 6 and Comparative Examples 1 to 6.
Boiling water test

| | | | | | | | Compar- | Compar- | Compar- | Compar- | Compar- | Compar- |
|---|---|---|---|---|---|---|---|---|---|---|---|---|
| | Coating | Coating | Coating | Coating | Coating | Coating | ative | ative | ative | ative | ative | ative |
| | Exam- | Exam- | Exam- | Exam- | Exam- | Exam- | Coating | Coating | Coating | Coating | Coating | Coating |
| RDS20, | ple | ple | ple | ple | ple | ple | Exam- | Exam- | Exam- | Exam- | Exam- | Exam- |
| 4′180° C. | 1 | 2 | 3 | 4 | 5 | 6 | ple 1 | ple 2 | ple 3 | ple 4 | ple 5 | ple 6 |
| cross cut | Gt1 | Gt0 | Gt0 | Gt0 | Gt2 | Gt0 | Gt1 | Gt2 | Gt1 | Gt0 | Gt0 | Gt0 |
| adhesion | | | | | | | | | | | | |
| cutting | 4 | 5 | 5 | 5 | 5 | 5 | 5 | 4 | 2 | 4 | 3 | 3 |
| edge | | | | | | | | | | | | |
| adhesion | | | | | | | | | | | | |
| scratch | 4 | 5 | 5 | 5 | 5 | 5 | 3 | 2 | 1 | 5 | 2 | 1 |
| after | | | | | | | | | | | | |
| folding | | | | | | | | | | | | |
| blush | 5 | 5 | 3 | 5 | 5 | 5 | 5 | 5 | 5 | 3 | 5 | 4 |

The results show that the coating compositions according to the invention perform as good as, or better than, those of the comparative examples.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A package coated on at least a portion thereof with a coating, the coating being derived from a coating composition, the coating composition comprising:
a. a polyamide imide (PAI) resin, and
b. a crosslinking agent comprising an isocyanate material and an epoxy material,
wherein the coating composition is substantially free of pyrrolidone solvents.

2. A package according to claim 1, wherein the polyamide imide (PAI) resin comprises from 20 to 95 mol % of amide linkages based on the total number of moles of imide and amide linkages present in the polymer backbone.

3. A package according to claim 1, wherein the polyamide imide (PAI) resin comprises from 5 to 80 wt % of imide linkages based on the total number of moles of imide and amide linkages present in the polymer backbone.

4. A package according to claim 1, wherein the polyamide imide (PAI) resin has a number-average molecular weight (Mn) up to 5,000 Da.

5. A package according to claim 1, wherein the polyamide imide (PAI) resin has an acid value from 15 to 100 mg KOH/g.

6. A package according to claim 1, wherein the coating composition comprises from 40 to 80 wt % of the polyamide imide based on the total solid weight of the coating composition.

7. A package according to claim 1, wherein the coating composition comprises from 30 to 60 wt % of crosslinking agent based on the total solid weight of the coating composition.

8. A package according to claim 1, wherein the coating composition comprises from 10 to 40 wt % of isocyanate material based on the total solid weight of the coating composition.

9. A package according to claim 1, wherein the coating composition comprises from 10 to 20 wt % of epoxy material based on the total solid weight of the coating composition.

10. A package according to claim 1, wherein the coating composition is a liquid composition.

11. A metal substrate coated on at least a portion thereof with a coating, the coating being derived from a coating composition, the coating composition comprising:
a) a polyamide imide (PAI) resin, and
b) a crosslinking agent comprising an isocyanate material and an epoxy material,
wherein the coating composition is substantially free of pyrrolidone solvents.

12. A metal substrate according to claim 11, wherein the metal substrate is a food and/or beverage container and/or a monobloc aerosol can and/or tube.

13. A method of making a metal package having a coating on at least a portion thereof, the method comprising the steps of:
i) applying a coating composition to at least a portion of a surface of a metal package, the coating composition comprising:
a) a polyamide imide resin (PAI), and
b) a crosslinking agent comprising an isocyanate material and an epoxy material, wherein the coating composition is substantially free of pyrrolidone solvents; and
ii) curing the coating composition to form a coating.

14. A method according to claim 13, wherein the coating composition is cured at a temperature from 180 to 200° C.

15. A method according to claim 13, wherein the metal package is food and/or beverage packaging and/or a monobloc aerosol can and/or tube.

16. A package according to claim 11, wherein the polyamide imide (PAI) resin comprises from 20 to 95 mol % of amide linkages based on the total number of moles of imide and amide linkages present in the polymer backbone.

17. A package according to claim 11, wherein the polyamide imide (PAI) resin comprises from 5 to 80 wt % of imide linkages based on the total number of moles of imide and amide linkages present in the polymer backbone.

18. A package according to claim 11, wherein the polyamide imide (PAI) resin has a number-average molecular weight (Mn) up to 5,000 Da.

19. A package according to claim 11, wherein the polyamide imide (PAI) resin has an acid value from 15 to 100 mg KOH/g.

20. A package according to claim 11, wherein the coating composition comprises from 40 to 80 wt % of the polyamide imide based on the total solid weight of the coating composition.

21. A package according to claim 11, wherein the coating composition comprises from 30 to 60 wt % of crosslinking agent based on the total solid weight of the coating composition.

22. A package according to claim 11, wherein the coating composition comprises from 10 to 40 wt % of isocyanate material based on the total solid weight of the coating composition.

23. A package according to claim 11, wherein the coating composition comprises from 10 to 20 wt % of epoxy material based on the total solid weight of the coating composition.
